(19) United States
(12) Patent Application Publication
(10) Pub. No.: US 2020/0175451 A1
(43) Pub. Date: Jun. 4, 2020

(54) HOSPITAL OPERATIONS MEASUREMENT AND PERFORMANCE ANALYSIS FACTORY INSTANCE OF A MEASURE FACTORY

(71) Applicant: Dimensional Insight Incorporated, Burlington, MA (US)

(72) Inventors: Douglass B. Powers, Medford, MA (US); James Clark, Andover, MA (US); Frederick A. Powers, Sudbury, MA (US); Daniel J. Jablonski, Stoneham, MA (US); Matthew J. Gorman, Wellesley, MA (US); George M. Dealy, Medfield, MA (US)

(21) Appl. No.: 16/786,585

(22) Filed: Feb. 10, 2020

Related U.S. Application Data
(63) Continuation-in-part of application No. 16/571,434, filed on Sep. 16, 2019.
Application No. 16/571,434 is a continuation of application No. 15/445,692, filed on Feb. 28, 2017, now Pat. No. 10,445,674.
(60) Provisional application No. 62/804,058, filed on Feb. 11, 2019.
(60) Provisional application No. 62/301,136, filed on Feb. 29, 2016.

(51) Int. Cl. G06Q 10/06; G06F 16/00; G06F 16/26; G06F 3/048; G06F 3/0484

(52) U.S. Cl. CPC G06Q 10/06316; G06Q 10/067; G06F 16/00; G06F 3/0484; G06Q 10/06; G06F 3/048; G06F 16/26

(57) ABSTRACT

A hospital operations measurement and performance analysis factory for generating analytic measures includes data sets representing business activities arranged as columnar arrays with each column being associated with a distinct source rule that applies to the column when it is used as a data source. The hospital operations measurement and performance analysis factory includes factory rules governing which operations on available data sources may be executed and under which conditions, such as by taking into account the source rules and other applicable factory rules. A factory rule execution hierarchy governs the execution of ready factory rules that lack dependency on other factory rules before executing ready factory rules that have dependency on other factory rules. An analytics measure rendering circuit facilitates flexibly presenting one or more measures of interest to a user/user role on a small form factor display.

### CLAIM TO PRIORITY

This application claims the benefit of U.S. Provisional Patent App. No. 62/804,058, filed on Feb. 11, 2019, and entitled “NAVIGATION AMONG GUIDED PAGES REPRESENTING COMMON DIMENSIONS OF A HOSPITAL OPERATIONS DATASET” (DMSL-0006-P01), the entirety of which is incorporated herein by reference.

This application is also a continuation-in-part of U.S. patent application Ser. No. 16/571,434, filed Sep. 16, 2019, and entitled “MEASURE FACTORY” (DMSL-0004-U01-C05), which is a continuation of U.S. patent application Ser. No. 15/445,692, filed Feb. 28, 2017, and entitled “MEASURE FACTORY” (DMSL-0004-U01), now U.S. Pat. No. 10,445,674, which claims the benefit of U.S. Provisional Patent App. No. 62/301,136, filed Feb. 29, 2016, and entitled “TECHNIQUES FOR GENERATING BUSINESS WORKFLOW-SPECIFIC DATA SETS BY APPLYING BUSINESS RULES TO DISTINCT COLUMNAR DATA SETS” (DMSL-0004-P01).

Each of the above applications are incorporated herein by reference in their entirety.

### BACKGROUND

Facilities for providing assessment, feedback, and determining a source of substantive changes in hospital operations performance often require a high degree of sophistication by a hospital operations business analyst and programmers to generate performance measurement and analysis that meet the need of individuals within diverse organizations. The bulk of the work required is rarely substantively transferrable to other use requirements and therefore presents an ongoing burden to organizations, and the like.

### SUMMARY

A hospital operations measurement and performance analysis factory instance of a measure factory constructed for generating analytic measures of hospital operations and the like may include data sets representing hospital operations and related activities. The data sets may be arranged as columnar arrays with each column being associated with a distinct source rule that applies to the column when it is used as a data source. The hospital operations measurement and performance analysis factory instance of a measure factory may include factory rules that govern which operations on available data sources may be executed under what conditions in the hospital operations measurement and performance analysis factory instance of a measure factory, such as by taking into account the source rules and other applicable factory rules. The hospital operations measurement and performance analysis factory instance may use a factory rule execution hierarchy that executes ready factory rules that lack dependency on other factory rules before executing ready factory rules that have dependency on other factory rules. The hospital operations measurement and performance analysis factory instance may also include a circuit generation facility that constructs customized circuits to process the plurality of factory rules and source rules according to, among other things the factory rule execution hierarchy. Constructed circuits may be applied to the plurality of data sets.

The hospital operations measurement and performance analysis factory instance executes constructed circuits independent of an order in which factory rules and/or data sets are presented to it. Therefore, the order of execution is independent of an order in which the factory rules, source rules, and/or data sets are detected. As a result, a measure factory instance, such as a hospital operations measurement and performance analysis factory removes a need for any understanding by the user of the required order of execution when casting data sets, source rules, and/or factory rules.

As noted above, only ready factory rules are executed. A factory rule may be determined to be ready when data that the factory rule requires is available in one or more of the plurality of data sets. This basic dependency on availability of required data for executing a factory rule provides structure for determining an order of execution of factory rules. As an example of ready factory rules, data is treated as available when the factory rule uses only source rules or when it is generated by another factory rule the processing of which is complete for the data that the factory rule requires.

The hierarchy of rule execution indicates that a ready calc factory rule is applied before other factory rules. Likewise, a ready flag rule is applied after all ready calc rules have been applied to a given data set. In this way, the hierarchy of factory rule execution indicates an order of factory rule execution. As a further clarification of the execution hierarchy, the order of factory rule execution requires ready calc, flag, and lookup rules to execute before ready link rules which execute before ready plugin rules.

The circuit construction facility may construct a circuit based on a data graph derived from references to the data sets in the factory rules. Specifically, the data graph may be constructed as a step in a process to construct a factory rule execution circuit. Also, the circuit construction facility may select among a plurality of factory rules based on an effectivity date associated with each of the plurality of factory rules and a circuit target date. The circuit target date may be the date on which the circuit is generated. Alternatively, the circuit target date may be an effectivity date of the circuit.

Methods and systems of a hospital operations measurement and performance analysis factory may include automated measurement of hospital operations performance through a combination of configuring a plurality of business performance hospital operations measurement and performance analysis factory rules as relationships of data source rules and of other factory rules; arranging a plurality of data sets with data representing business activities as columnar arrays wherein each column is associated with a distinct source rule; generating a circuit for processing the plurality of data sets from the factory rules based on a factory rule execution hierarchy that executes ready factory rules that lack dependency on other factory rules before executing ready factory rules that have dependency on other factory rules; and processing the plurality of data sets with the generated circuits to produce a business measure.

Other methods and systems described herein may include managing a business operation through insight into the operation generated by defining measures of data, such as data for operating the business, that characterize the operation at a level of abstraction that is independent of a source and/or location of data (or presence thereof) in the data that characterizes the operation. Optionally, references to data in the measures map to types of data and/or rules of the data that characterize the operation.

In another aspect of the hospital operations measurement and performance analysis factory methods and systems described herein, a hospital operations measurement and performance analysis factory output dashboard may be automatically configured based on factory rule definitions and an indication of at least one dimension of data that the factory rule impacts. The automatic configuration may cause arranging measures on the dashboard to visually align with the at least one dimension. The output dashboard may be automatically re-configured to display measures that, upon processing of a set of hospital operations measurement and performance analysis factory rules according to an execution hierarchy, correspond to a pattern of interest defined by an operator of the hospital operations measurement and performance analysis factory. In some cases, the pattern of interest is defined by departure of a measure from a historical range for the measure.

A data set including diverse data from operations of a hospital group is gathered through various operations of the hospital, such as admissions, diagnosis, emergency services, treatment, and the like. The data set may include information about admissions, patients, physicians, diagnosis, treatment, surgeries, and the like. The data may further include similar data from a plurality of facilities that make up the hospital group (e.g., individual hospitals, outpatient centers, and the like). The data set may be processed using the methods and systems described herewith that provides methods and systems of a hospital operations measurement and performance factory, including without limitation methods and systems for processing factory rules, ready rules, and the like for seeking a dynamically generated understanding of key measures or metrics. Content produced by a measures factory may include a plurality of key performance indices (KPIs) and the like that provide operations, performance, and other measures of a range of collection controls, such as emergency department measures (e.g., 48 hour returning patients, 72 hour returning patients, admissions, visits, and the like), acute patient measures (e.g., admissions, discharge days, patient days, discharges, and the like).

In embodiments, rendering of measures produced by the factory for small form factor digital screens, such as smart phones and the like that may have rectangular screens as small as 3 inches by 5 inches or less, may require a different approach than that associated with a factory output dashboard as described herein. Such an approach may require greater flexibility given the end user for viewing combinations of measures, time frames, dimensions and the like in a small form factor display. However, given that processing a data set with a hospital operations measurement and performance factory may produce many more measures than could be presented on a small form factor screen, an approach that blends measurement selection and screen utilization may be required. Such an approach, referred to herein as construction, configuration, and use of factory measure rendering circuits provides an end user with the guided tools required for use of a hospital operations measurement and performance factory with a small form factor screen.

In embodiments, a hospital operations measurement and performance analysis factory for generating analytic measures is provided. The factory includes: a plurality of data sets including data representing business activities arranged as a columnar array wherein each column is associated with a distinct source rule that applies to the column when it is used as a data source; a plurality of factory rules that govern which operations on available data sources may be executed under what conditions in the hospital operations measurement and performance analysis factory; a factory rule execution hierarchy that executes ready calc, flag, and lookup rules before executing ready link and ready plugin rules; and an analytic measures rendering circuit that gathers a subset of the analytic measures produced by applying the plurality of factory rules per the factory rule execution hierarchy to a portion of the plurality of data sets into a structured set of discrete panels, wherein each analytic measure in the subset of measures is rendered in one panel in the subset of discrete panels. In certain embodiments, an order in which factory rules are presented to the hospital operations measurement and performance analysis factory is independent of an order in which the presented factory rules are applied to the plurality of data set. In certain embodiments, a factory rule is determined to be ready when data of the plurality of data sets that the factory rule requires is available in one or more of the plurality of data sets. In certain embodiments, data required by at least one factory rule is available when at least one of the following conditions exists: (a) the data is determined only by application of source rules; and (b) the data is generated by another factory rule the processing of which is complete for data that the at least one factory rule requires. In certain embodiments, factory rules that lack dependency on other factory rules are applied before applying factory rules that have dependency on other factory rules. In certain embodiments, the analytic measure rendering circuit is structured to facilitate rendering of the plurality of discrete panels. In such embodiments, a value of an analytic measure of the plurality is calculated for at least two different time frames and a comparison thereof is rendered in each discrete panel. In certain embodiments, the analytic measure rendering circuit indicates a visual order of factory measure presentation on a small form factor electronic display. In certain embodiments, the order of factory rule execution further requires the ready calc, flag, and lookup rules to execute before the ready link rules which execute before the ready plugin rules. In certain embodiments, the factory further includes a measure-specific circuit generation facility that generates a circuit for executing a combination of source rules and factory rules on a subset of the plurality of data sets to produce a first measure. In such embodiments, the facility generates the circuit based on a data graph derived from the plurality of data sets in the factory rules. In certain embodiments, the circuit generation facility generates the data graph as part of a process to create the circuit. In certain embodiments, the circuit generation facility selects among a plurality of factory rules based on an effectivity date associated with each of the plurality of factory rules and a circuit target date. In certain embodiments, the circuit target date is the date on which the circuit is generated. In certain embodiments, the circuit target date is an effectivity date of the circuit.

In embodiments, a method of automated measurement of business performance is provided. The method includes configuring a plurality of business performance hospital operations measurement and performance analysis factory rules as relationships of data source rules and of other factory rules. The method further includes arranging a plurality of data sets with data representing business activities as columnar arrays wherein each column is associated with a distinct source rule. The method further includes generating a circuit for processing the plurality of data sets from the factory rules based on a factory rule execution hierarchy that executes factory rules that lack dependency on other factory rules before executing factory rules that have dependency on the other factory rules; and processing the plurality of data sets with the generated circuits to produce a business measure. In certain embodiments, an order in which factory rules are presented to the hospital operations measurement and performance analysis factory is independent of an order in which the generated circuit executes the presented factory rules. In certain embodiments, a factory rule is determined to be ready when data that the factory rule requires is available in one or more of the plurality of data sets. In certain embodiments, the data is treated as available when at least one of the following conditions exist: (a) if it is determined only by application of source rules; and (b) if it is generated by another factory rule the processing of which is complete for the data that the factory rule requires. In certain embodiments, a ready calc factory rule is applied before other factory rules. In certain embodiments, a ready flag rule is applied after all ready calc rules have been applied per the circuit.

In embodiments, an apparatus for providing an analytic measure rendering is provided, the apparatus includes a data gathering circuit and a rendering circuit. The data gathering circuit is structured to communicate with a hospital operations measurement and performance analysis factory, and to gather a plurality of analytic measurements produced via the hospital operations measurement and performance analysis factory by applying a plurality of factory rules to a plurality of data sets based on a factory rule execution hierarchy. The factory rule execution hierarchy executes ready calc, flag, and lookup rules before executing ready link and ready plugin rules. The rendering circuit is structured to generate a plurality of panels for display in a graphical user interface, and render at last one of the plurality of analytic measurements in a corresponding panel of the plurality of panels.

In another aspect of the hospital operations measurement and performance analysis factory methods and systems described herein, a hospital operations measurement and performance analysis factory user interface that facilitates defining a hospital operations measurement and performance analysis factory may include defining data set source rules that associate data within a plurality of columnar data sets, factory rules that govern at least one of extraction, transformation, computation, and loading of data within and among the plurality of data sets, user-selectable dimensions within the data set around which a user interface for viewing an output of the hospital operations measurement and performance analysis factory is arranged, and measures that are presented in the user interface.

Methods and systems for new and novel applications of a hospital operations measurement and performance analysis factory may include automated detection of difference of business-specific performance measures via automated computation of measures by applying source rules and factory rules to business-specific data. The differences may be automatically detected by comparing measures to normalized measures of the same type to identify departures from normal. The normalized measures may be established based on historical averages. They may also be established based on past time periods.

Other applications of a hospital operations measurement and performance analysis factory may include automated detection of at least one variance-impacting dimension of a plurality of dimensions of data that contribute to a measure of business performance of business activities that are represented at least in part by the data. In this application, detection may include: determining data that contributes to the measure of business activity; comparing differences between at least one of summaries of the determined data and elements of the determined data for a plurality of varying measures, the variances may be variation in measure time-periods; ranking at least a plurality of the differences from largest to smallest of the plurality of the differences; and presenting descriptive data for the top ranked differences to a user in an electronic user interface of a computer. The user interface may facilitate selecting the plurality of varying measures, such as by selecting timer periods.

Yet other applications of hospital operations measurement and performance analysis factory methods and systems may include automatically ranking by degree of impact, business activities that impact a change in business performance detectable from a comparison of a plurality of distinct time period-specific measures of business performance, the measures generated by processing data representing the business activities for the plurality of time periods, such as with a hospital operations measurement and performance analysis factory. Processing with a hospital operations measurement and performance analysis factory may include applying data processing circuits to data representing the business activities. The circuits may automatically be generated from one or more combinations of: a plurality of factory rules described as relationships of source rules and relationships of other factory rules; a plurality of data sets including data representing the business activities arranged as a columnar array wherein each column is associated with a distinct source rule; and a factory rule execution hierarchy that indicates ready factory rules without dependency on other factory rules are executed before ready factory rules with dependency on other factory rules.

In any of the hospital operations measurement and performance analysis factory methods and systems described herein, factory rules that apply only to data within a specific data set may be executed independently of factory rules that apply to data within other data sets.

Another application of hospital operations measurement and performance analysis factory methods and systems may include projecting a difference of a business performance measure based on analysis of differences over time of data elements that, when processed through a hospital operations measurement and performance analysis factory, produce measures of the business performance.

Still another application of hospital operations measurement and performance analysis factory methods and systems may include suggesting a business activity as a source of a variance between two business-centric performance measures of a business, the measures generated by processing data representing activities of the business with a hospital operations measurement and performance analysis factory.

Suggesting an event that is characterized by data within a data set as a source of a variance between two business-centric performance measures of a business is an additional application of the hospital operations measurement and performance analysis factory methods and systems described herein. The measures may be generated by processing data representing activities of the business with a hospital operations measurement and performance analysis factory.

Automated variance detecting applications of a hospital operations measurement and performance analysis factory may include a business operational dashboard that automatically presents contributors to notable variances of a measure of business-performance over time. The contributors may be determined from sources of measures as defined by a set of factory rules of a hospital operations measurement and performance analysis factory. The contributors may further be tagged with a variance-impact confidence factor. Additionally, the dashboard may be automatically configured based on a determined role of a user of the dashboard. The contributors may be further filtered based on the determined role of the user so that sources of data for contributors associated with the determined role of the user are represented in the dashboard by descriptive information about role-specific business activities that correspond to the sources of data for the filtered contributors.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a diagram of elements of a hospital operations measurement and performance analysis factory.

FIG. 2 depicts a diagram of data sets and rules of a hospital operations measurement and performance analysis factory.

FIG. 3 depicts a calculation factory rule.

FIG. 4 depicts a lookup factory rule.

FIG. 5 depicts a flag factory rule.

FIG. 6 depicts a link factory rule.

FIG. 7 depicts a plugin for use with a hospital operations measurement and performance analysis factory.

FIG. 8 depicts hospital operations measurement and performance analysis factory data set rule processing.

FIG. 9 depicts a flow chart of processing ready rules.

FIG. 10 depicts a hospital operations measurement and performance analysis factory embodiment for generating a charges cBase and an Accounts cBase.

FIG. 11 depicts a table that represents a charges data set.

FIG. 12 depicts a table that represents an account data set.

FIG. 13 depicts a table that represents data used by a lookup factory rule.

FIG. 14 depicts a table that represents a data set used by a flag factory rule.

FIG. 15 depicts a table that represents measure configuration and description information.

FIG. 16 depicts a hospital operations measurement and performance analysis factory executive dashboard.

FIG. 17 depicts a dashboard in a user interface of a hospital operations measurement and performance analysis factory for measures based on recent time periods.

FIG. 18 depicts a table of measures in a hospital operations measurement and performance analysis factory user interface.

FIG. 19 depicts a multi-view dashboard in a hospital operations measurement and performance analysis factory user interface.

FIG. 20 depicts an application of a hospital operations measurement and performance analysis factory for automated analysis.

FIG. 21 depicts an electronic interface of time frame-specific measures of operations of a hospital group.

FIG. 22 depicts an electronic interface of time frame-specific measures for a select measure of a select hospital in the hospital group.

FIG. 23 depicts an electronic interface of time frame-specific measures for a select service line dimension of a select hospital in the hospital group.

FIG. 24 depicts an electronic interface of time frame-specific measures for a select dimension of across the hospital group.

FIG. 25 depicts an electronic interface of time frame-specific data contributing to a select measure of a select service line dimension in the hospital group.

FIG. 26 depicts an electronic interface including a time-series graph of data values for a specific domain of data that contributes to a select measure in the hospital group.

FIG. 27 depicts an electronic interface of time frame-specific measures for a select time-frame of the time-series graph depicted in FIG. 6 for the hospital group.

FIG. 28 depicts an electronic interface of a list of providers and their contributions to a select measure of a select service line dimension in the hospital group.

FIG. 29 depicts an electronic interface of time frame-specific measures for a select provider domain of a select service line dimension in the hospital group.

FIG. 30 depicts an electronic interface of a list of data types that contribute to a select time frame-specific measure of a select service line dimension in the hospital group.

FIG. 31 depicts an electronic interface of time frame-specific measures for a select data type from the list of data types depicted in FIG. 10.

FIG. 32 depicts a list of measure multi-view pages of measures produced by a hospital operations measurement and performance factory from which a user can select one for displaying on a small form factor screen display.

FIG. 33 depicts a first measure multi-view page from the list of multi-view pages in FIG. 32 produced for a small form factor screen display in portrait mode.

FIG. 34 depicts a second measure multi-view page from the list of multi-view pages in FIG. 32 produced for a small form factor screen display in portrait mode.

FIG. 35 depicts an automated landscape adapted rendering on the small form factor screen display of the measure multi-view page of FIG. 34.

FIG. 36 depicts a scrolled view of the measure multi-view page of FIG. 35.

FIG. 37 depicts a third measure multi-view page from the list of measure multi-view pages in FIG. 32 produced for a small form factor screen display in portrait mode.

FIG. 38 depicts a landscape rendering on the small form factor screen display of the multi-view page of FIG. 37.

FIG. 39 depicts a fourth measure multi-view page from the list of measure multi-view pages in FIG. 32 produced for a small form factor screen display in portrait mode.

FIG. 40 depicts a landscape rendering on the small form factor screen display of the measure multi-view page of FIG. 39.

FIG. 41 depicts a user interface screen capability that includes editing views in a multi-view page.

FIG. 42 depicts a landscape rendering on the small form factor screen display of the user interface screen capability of FIG. 41.

FIG. 43 depicts an embodiment of a measure view type constructed to facilitate production and display of a measure produced by a hospital operations measurement and performance factory.

FIG. 44 depicts an embodiment of a measure view type configured with measure data resulting from use of the measure view type to activate an instance of the hospital operations measurement and performance factory to produce a specific measure.

FIG. 45 depicts a flow diagram for producing a measure view type.

FIG. 46 depicts a flow diagram for configuring a hospital operations measurement and performance factory to generate a specific measure using a combination of a measure view type and a hospital operations measurement and performance factory output measure.

FIG. 47 depicts production of a specific measure with the hospital operations measurement and performance factory based on a user selected measure view type.

FIG. 48 depicts a flow diagram of rendering, with a user interface on a small form factor screen, a measure multi-view page selected from a list of such pages.

FIG. 49 depicts a block diagram of a measure view panel as may be presented for rendering measure data produced by a hospital operations measurement and performance factory on a small form factor display.

### DETAILED DESCRIPTION

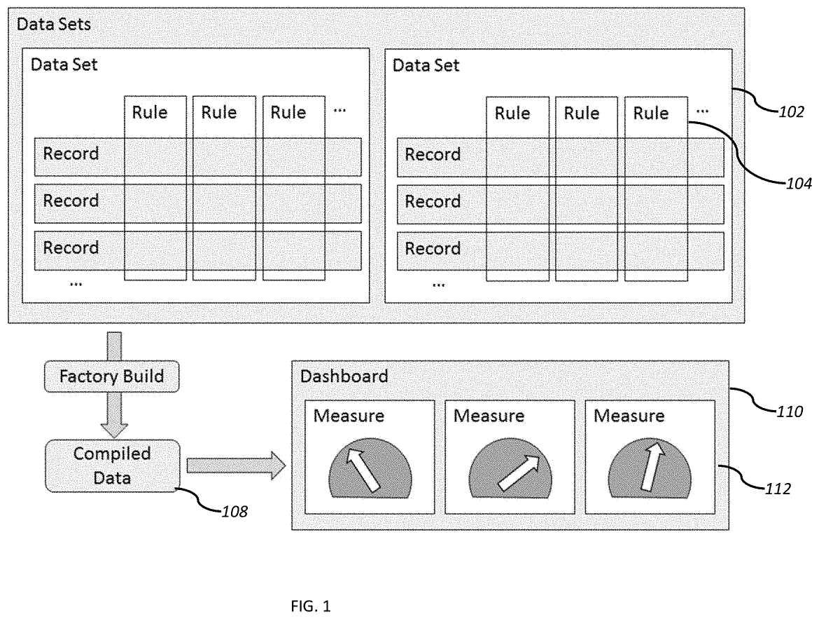

Referring to FIG. 1, an embodiment of a hospital operations measurement and performance analysis factory, data sets, rules, measures and views are depicted. In embodiments, a data set 102 may be a collection of records, each of which may describe a particular kind of object, event, or relationship. Typically, data sets include data that represent some aspect of a business or business process. As an example, an “Accounts” data set may have records for individual accounts of a business (e.g., an account maybe associated with a customer or patient of the business); there may be one record for each such account.

Records in a data set may have a number of facts, or individual pieces of information, associated with them. Individual records may have certain kinds of facts that are unique to the record (e.g., a record identifier). However, other kinds of facts may be common to some or all of the records in the data set. For simplicity, each common type of fact is referred to herein as a source rule 104 of the data set. Generally, each source rule 104 is common to all records in a data set 102. As an example, the Accounts data set may have rules such as “Account ID”, “Admit Date”, “Purchase Date”, and the like. The “Admit Date” rule may indicate an admission date type of fact for each record.

Goals of the hospital operations measurement and performance analysis factory methods and systems described herein includes adding new rules (new types of facts) to a collection of data sets, and making it easier to create and manage a large number of rules. The hospital operations measurement and performance analysis factory methods and systems described herein may automate the definition, generation, and processing of the rules, so the people working with the business data can focus on the correctness of the rules for generating meaningful measures, independent of the implementation of those rules, such as in terms of the requirements for preparing data for each rule and the flow of data from source data sets to final data sets.

One structural output of applying the hospital operations measurement and performance analysis factory methods and systems described herein may be a set of data structures, e.g. enhanced and newly created data tables 108 that support business-centric uses of the data. One such use may be an interactive electronic user interface or dashboard 110 for operating a portion of a business associated with the data in the data sets 102. As an example, data output by a hospital operations measurement and performance analysis factory may be displayed in summary form, such as depicting a number of Accounts with Admit Dates occurring this month. The summary form may be a single number, such as 286. The hospital operations measurement and performance analysis factory methods and systems described herein may summarize data in many ways. Each such way of summarizing data may be called a “measure” 112. A measure is typically the result of applying some mathematical expression to a specific set of rule values from a collection of records in one or more data sets.

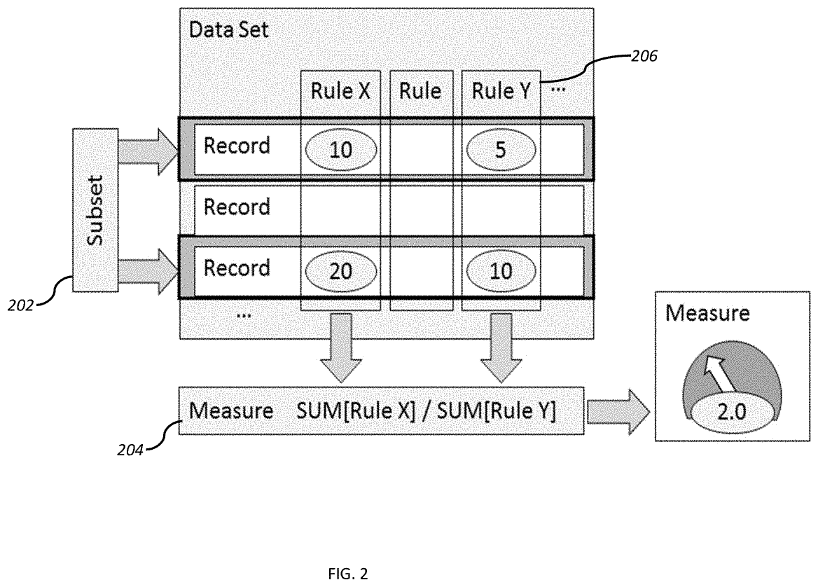

Referring to FIG. 2 that depicts a diagram of data sets and rules of a hospital operations measurement and performance analysis factory, data sets 102 may be arranged as subsets of records. Subsets may be dynamically configured based on relationships of data in the records for specific rules. As an example, subset 202 including the first and third rows in the example embodiment of FIG. 2 may define data for rule X and rule Y that meet certain criteria, such as a non-zero value, a value relative to a threshold (e.g. above or below a threshold value) or relative to a set of thresholds (e.g. within or outside a range). A measure may result in a set of records from a data set, such as subset 202 being processed by a factory rule 206 to produce a result, such as a summary, mathematical outcome, logical outcome and the like. In the example of FIG. 2, the measure 204 sums the values of records in subset 202 defined by rule x and divides that sum by the sum of values of records in subset 202 defined by rule y.

Measures may have associated data which helps to support rich displays, such as a description, a flag indicating whether the measures are “better” when it goes up or down relative to a prior time period or other measure, a set of preferred columns to access when analyzing the measure, and the like.

Measures may also be associated with a “view”, which is an abstraction over the rules available in a data set. A view may assign specific rules to abstract rule concepts, to further separate a fact type from a corresponding rule. For instance, the abstract concept of “Date” may be specifically assigned to “Admit Date” for the “Admissions” measure, but it may be assigned to “Discharge Date” for the “Discharges” measure. This allows the dashboard to show the Admissions and Discharges measures together over a general time range (such as year-to-date), even though the two measures have a different concrete notion of which date rule is relevant to them.

More specifically, a view may be an abstraction of rules independent of what the underlying rule represents, e.g., different types of “date” can all be abstracted to a “date” view-level rule type. This way “admit date” and “discharge date” can both be treated as a “date” in a view-level “date” rule. As an example, a measure of admissions can reference a date value in admissions data set records. The date in these records would be an admission date. Similarly, a measure of discharges that accessed a data set of discharge records would reference the date in each record that would be a date of discharge. This is a simple abstraction example, but generally all rules to be abstracted to a view-level rule will typically be of the same general type (e.g., a date, a facility, a procedure or the like).

The hospital operations measurement and performance analysis factory methods and systems described herein may include different types of rules, such as source rules 104, factory rules 206, and the like. Examples of types of rules are described in the following paragraphs and corresponding figures.

A first type of rule may be a source rule. Source rules may be associated with types or dimensions of data in a hospital operations measurement and performance analysis factory data set. As an example, a data set may be configured by extracting data from one or more external data stores, such as data stores, databases, data streams, and the like that may be associated with an aspect of a business for which the hospital operations measurement and performance analysis factory may be configured to analyze. A hospital operations measurement and performance analysis factory data set may preferably be configured as a columnar database (herein referred to as a cBase). The columns in such a cBase may be automatically made available as source rules in the data set. As source cBase data sets are processed by the hospital operations measurement and performance analysis factory, other types of rules (e.g., additional columns) may be added. Although not intended to be limiting, processing of one or more data sets by the hospital operations measurement and performance analysis factory may be referred to herein as a “factory build”.

In addition to source rules, there are several types of factory rules 206 that may be referenced during the generation of a hospital operations measurement and performance analysis factory processing deployment. Such factory rules 206 may be used to define measures by a person or may be automatically configured into a set of cohesive data processing hospital operations measurement and performance analysis factory data processing operations.

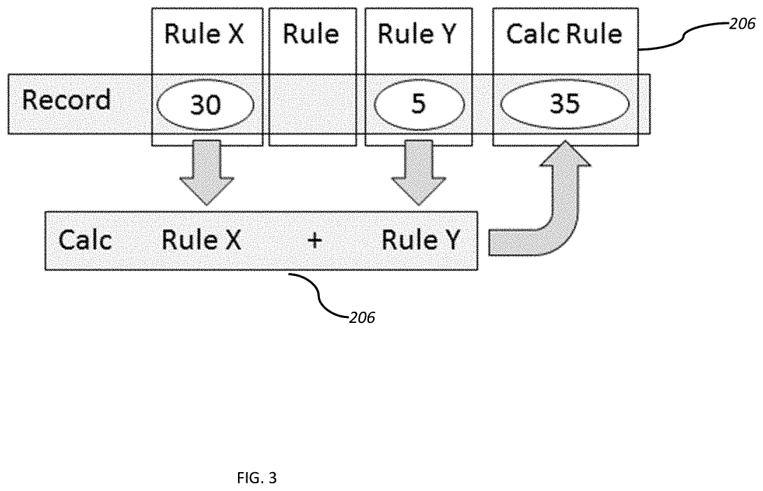

FIG. 3 depicts a first type of factory rule, specifically a calculation rule (herein referred to as a “calc” rule). A calc rule may generate new data that may be added to one or more of the records in a data set by applying one more mathematical expressions to data associated with existing rules in a data set. The use of a calc rule example of FIG. 3 defines a factory rule 206 referred to as “Admission”. This factory rule 206 may be defined by a user as value(“Patient Type”)—“Inpatient” and value(“Admit Date”) !—null. This could be interpreted as assigning a value to a new rule “InPatient” for each processed record (e.g., adding this new rule as a new column to a cBase data set, such as an Admissions data set). A circuit that could automatically be generated by the hospital operations measurement and performance analysis factory based on the factory rule 206 definition above may simply be: calc-rule “Admission” ‘value(“Patient Type”)=“Inpatient” and value(“Admit Date”) !=null’. The result of such a rule may cause each processed record that has a non-null Admit Date value to be classifiable as an Inpatient record. The value “Inpatient” could be a binary value (e.g., 1 or 0, or may be a more involved value, such as a text string, formula, or the like).

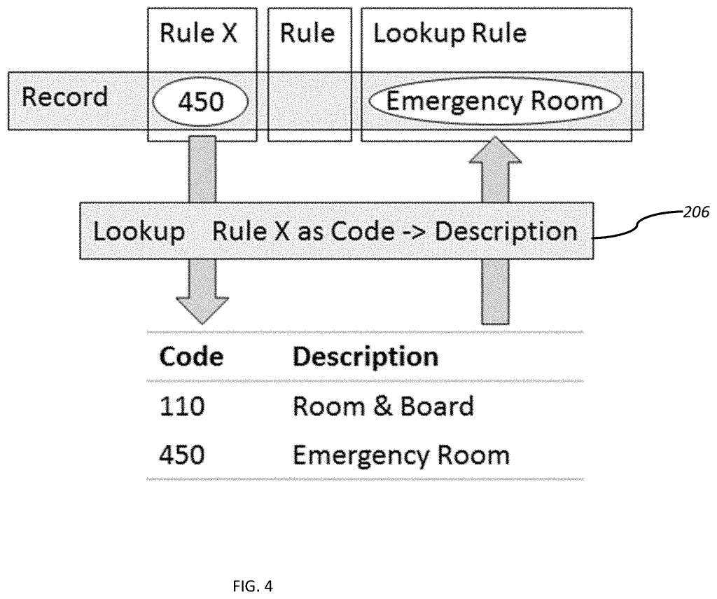

FIG. 4 depicts another type of factory rule 206 that may perform data lookups for assigning one or more data values associated with one or more source rules into a group. A lookup rule may get information from a lookup file and may match certain values from certain rules in each processed record with values in the lookup table. The lookup table may be configured with a set of rows that include a lookup code that may be matched to the value of each processed data set record and a description value that may be added to each processed record in a new column associated with the rule for which the lookup is performed.

An example use of a lookup rule is to convert codes into text descriptions. In the lookup factory rule 206 example of FIG. 4, the lookup rule converts “Revenue Code” (depicted as “Rule X”) to “Revenue Description” (depicted as “Lookup Rule”). A lookup file, would be accessed and the “Revenue Code” rule value in each processed cBase record would be used as an index into the lookup file. A corresponding “Revenue Description” value in the lookup file would be placed in a “Revenue Description” column of the processed record. An automatically generated circuit to define such a rule might include: lookup “Revenue Descriptions” {date rule=“Posting Date”; key “Revenue Code”; lookup-rule “Revenue Description”}

In some cases, a lookup rule could be implemented as a calc rule, but lookups have advantages over plain calc rules. Lookups are easier to maintain. As an example of easier maintenance, one can modify the lookup values by editing the lookup table directory, and the lookup table can be generated by an external process. Lookup rules can also access an “effective date range” for each entry in the lookup table. Therefore, if a preferred mapping between an index and a description in the lookup table changes over time, the effective date range values in a lookup tale entry can reflect that change and return the mapped value appropriate to the time associated with the record. In an example, if Revenue Code 123 meant “Emergency Room—Other” for transactions that occurred before Jan. 1, 2015, but it meant “Urgent Care” for transactions on or after that date, then the lookup table can be set up to facilitate accessing the appropriate Revenue Code 123 for each execution of the hospital operations measurement and performance analysis factory. The effective date range may be matched to a target date range for the execution of the hospital operations measurement and performance analysis factory. In this way, the data added to the cBase column for each processed record may correspond to a preferred effective date. Further in this example, a target date may be predefined, may be calculated by a factory rule, may be referenced in the processed record, and the like.

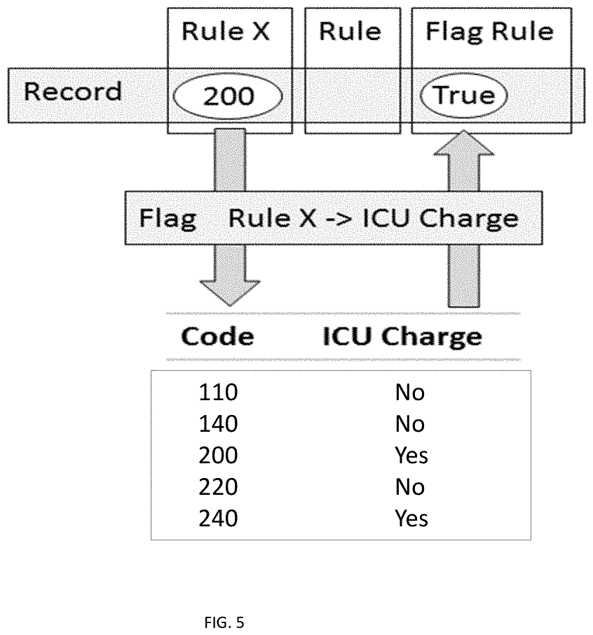

Referring to FIG. 5, another factory rule 206 is depicted for flagging certain records in the cBase based on values in the record. Whereas a lookup rule can result in any string or other value being loaded to a cBase column in each processed record in a data set based on other values in the record, a flag rule results in one of two values being added to the cBase record. This rule is generally useful for mapping records, based on a select rule value (e.g., Revenue code) as either included or excluded from a particular set of records. In the example of FIG. 5, records with revenue code 110 are not included in an ICU charge group of records, whereas records with revenue code 200 are included. Additional entries in the flag table could allocate records with other revenue codes to be included or excluded from the ICU charge group. In this way, further processing can be based on whether the record is an ICU charge (included in the ICU charge group) or not (excluded from the ICU charge group).

An automatically generated circuit for processing records with the flag rule of FIG. 5 may include: flag-table “Revenue Flags” {date rule=“Posting Date”; key rule=“Revenue Code”; flag-rule “ICU Charge” }. When this circuit executes, Revenue Codes in processed records will be matched to the Revenue Flags file entries. Where there are matches, if the record value Posting Date is within the effective dates for the matched Revenue Flags file entry, a new value (e.g., true/false) will be added to the “ICU Charge” cBase column in the processed record.

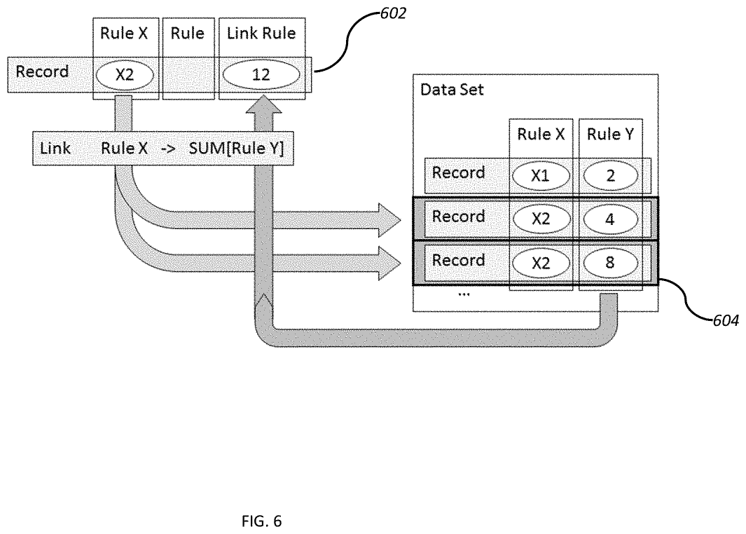

Referring to FIG. 6, a factory rule 206 for linking data among data sets is depicted. A link rule may also be used to move or duplicate data from one data set to another. A link rule may use a “key”, which may be a rule in an origin data set that is used to match data records for the corresponding rule in another data set herein called a matching data set. The link rule may facilitate connecting or associating records from the two data sets which share the same value for the selected key. As an example of a link rule key, both an Accounts (origin) and a Charges (matching) data set may have an “Account ID” rule in them. Data in the two data sets for records that have the same value in the “Account ID” rule (or column in a columnar data set) may be used in an operation associated with the link rule. The operation associated with the link rule, may include a summarizing mathematical expression that may be applied to the records in matching data set. The result of the expression may be placed in the corresponding record(s) in the origin data set. In the example of FIG. 6, an origin data set 602 includes a rule X that is used as a key for a link rule. A record in the origin data set 602 has a value of X2 for the key. This value X2 is used to find records in the matching data set 604 that have the same key value. An expression associated with the link rule causes other values in the matching records, such as by reciting an operation to perform on specific rules (e.g., Rule Y in FIG. 6) in the matching data set. The operation is performed on all records in the matching set that contain the key value. In the example of FIG. 6, the values in Rule Y of each corresponding record in the matching data set are summed. The result is loaded into a new link rule column in the appropriate record in the origin data set. In the example of FIG. 6, records in an Accounts data set will be updated with a total of charges found in the Charges data set for records in the Charge data set that match the Account ID of each record in the Accounts data set. This results in each Accounts record now including a total of charges for the account. While a summing expression is used in the example of FIG. 6, any logical, mathematical, or other expression may be used.

A circuit that may be automatically generated and executed by the hospital operations measurement and performance analysis factory for the link rule example of FIG. 6 may be: link “Charges” {key “Account ID”; link-rule “Has ICU Charge” count( )>0′filter=‘value(“ICU Charge”)’}. In this example, a default operation performed by the link rule is a mathematical summation of the ICU charges for each Account ID found in the Accounts data set.

Through the automated processing of factory rule 206 definitions as described later herein, multiple-dependencies among data sets may be safely ignored by the user. The hospital operations measurement and performance analysis factory determines which rules (e.g., operations) must be performed to satisfy any cross-data set dependencies.

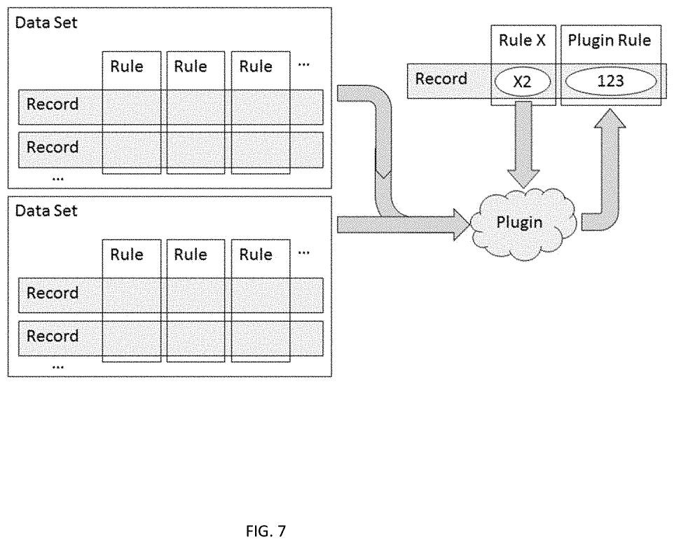

FIG. 7 depicts another type of factory rule 206 that provides a rich data processing capability to a user without overly complicating the hospital operations measurement and performance analysis factory, specifically a plugin rule. As an example, a plugin rule is available to produce rules that are not possible using the other rule types. A plugin rule may execute an external process to determine the rule values, deliver data based on those values to the external process that performs operations with the delivered data from the data sets, and then join the result of that external process back into the data set(s). This allows the user to inject more complicated logic into the factory while still taking advantage of the hospital operations measurement and performance analysis factory's automatic management of the data flow.

As an example of a plugin rule, computing whether an Admission is a “Readmission” may need to determine if the current Admission encounter occurred within a certain number of days after a previous encounter of the same patient. This requires looking at data outside of each individual account record (e.g., prior account encounter records). A plugin rule can be defined to handle readmission calculations.

A readmission plugin rule may be configured by a user and the hospital operations measurement and performance analysis factory may automatically generate the following circuit for it: plugin “Readmission” {input “Accounts” {column “Account ID”; column “Admission”; column “Admit Date”; column “Discharge Date”; column “DRG”; column “MRN”} dimension “Account ID”; plugin-rule “Readmission”}

A feature of a hospital operations measurement and performance analysis factory is its ability to automatically manage the application of rules, so that a user configuring the factory can focus on defining factory rules 206. The methods and systems of a hospital operations measurement and performance analysis factory free the user from needing to track when data that may be needed for a factory rule 206 is ready for use. The hospital operations measurement and performance analysis factory isolates the user activity of defining rules from their processing.

A hospital operations measurement and performance analysis factory may process data using a “swim lane” method, embodiments of which are described in U.S. provisional patent application Ser. No. 62/301,136, the entirety of which is incorporated herein by reference. Each data set may be built up from a source table, rule by rule, until all rules are applied. The use of a swim lane analog is useful to visualize the rule execution hierarchy and overall data processing approach. All processing that can be performed on data in a data set without requiring access to other data sets (that may also be being processed) is performed within the swim lane of the data set, thereby providing independent processing of each data set in its own swim lane without affecting other data sets. Most of the time, a data set will stay in its swim lane, but for certain rule types (e.g., link and plugin) it may be necessary to transfer data from one lane to another.

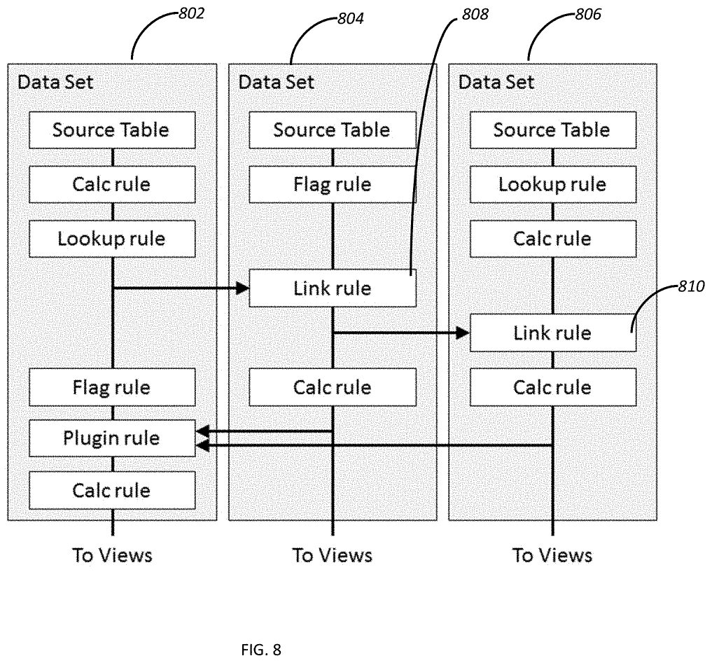

FIG. 8 depicts an embodiment of a hospital operations measurement and performance analysis factory data flow process for three data sets (802, 804, 806). A data set 802 performs a calc factory rule 206 and a lookup factory rule 206 before pausing processing to provide data to a link rule 808 operating in a circuit for data set 804. The data set 802 rules processing continues once the lookup rule is complete. A circuit for processing the data set 802 resumes by processing a flag rule and then executing a plugin rule 808 for accessing data from the data sets 804 and 806. The rule circuit of data set 802 finishes by executing a calc factory rule.

A circuit for processing rules for the data set 804 processes a flag rule followed by the link rule 808 through which it accesses summary data from data set 802 after completion of that data set's lookup rule. Processing may pause temporarily while the circuit for data set 806 processes a link rule 810 that accesses data from data set 804. Note that the data generated by the circuit for data set 804 may include summary data from data set 802 at the time that the link rule 810 in the circuit for data set 806 executes. In this way, the circuit for data set 806 is configured to execute its link rule 810 only after data in data set 804 includes the summary data generated from executing the link rule 808. While a user definition of the link rule 810 may require the summary, data generated by link rule 808 execution, the user does not have to explicitly recite that link rule 808 be performed before executing link rule 810. A hospital operations measurement and performance analysis factory automated circuit processing facility determines this dependency based on the link rule 810 definition, an understanding of the data in each of the data sets, link rule 808 definition and the like. This may, for example, be determined from a data graph generated by the hospital operations measurement and performance analysis factory during generation of the circuits.

Methods and systems of a hospital operations measurement and performance analysis factory as described herein may include execution of a circuit of rules that may be automatically generated by the hospital operations measurement and performance analysis factory. This automated rule execution may involve executing a large number of rules across a large number of data sets. Rules may process data within a single data set or may require use of data from multiple data sets. A rule processing set or algorithm may determine a general order or hierarchy of rule processing. One aspect of such an algorithm is the notion that only rules for which data is available can be processed. This may be referred to herein as a rule being ready. Therefore, a rule is considered “ready” if it does not depend on a rule which hasn't yet been applied so that data required by rule is not yet available. The algorithm facilitates only applying a rule until it is ready. The hospital operations measurement and performance analysis factory rule 206 processing algorithm indicates that all ready calc, flag, and lookup rules are to be processed in order. These rules would not be executed because they would not be ready if they require data output from any rule that has not yet executed. Therefore, an order of execution of calc, flag, and lookup rules are based on availability of data within the given data set. After applying all ready calc, flag, and lookup rules, a hospital operations measurement and performance analysis factory rule processing facility may process ready link and plugin rules. Processing continues by processing more calc, flag, and lookup rules that are ready that have not yet been executed. Execution of rules continue with this general hierarchy until all rules are complete.

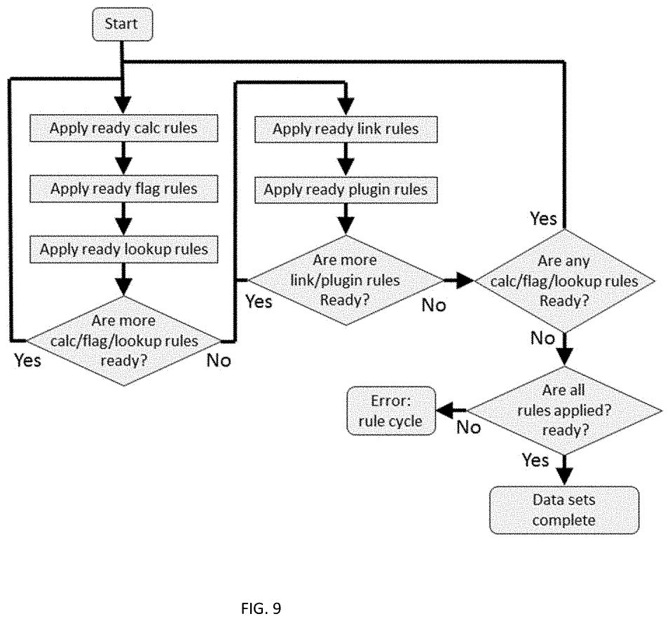

FIG. 9 depicts a flow of rule execution based on this hospital operations measurement and performance analysis factory rules processing algorithm, in accordance with embodiments. All ready rules are executed across all data sets in an instance of hospital operations measurement and performance analysis factory rule processing so that at any time rules that do not depend on unavailable data may be executed. This facilitates highly efficient use of computer resources, scalability of the number of data sets, rules, and measures. It also facilitates use of distributed processing architectures and the like. Rules processing may, for example be distributed across networked processors so that data operations can be localized for data sets that are stored locally with each networked processor.

In embodiments, a columnar database processing engine referred to in U.S. patent application Ser. No. 15/164,546 the entirety of which is incorporated herein by reference as a Spectre data processing engine may be employed to perform one or more of the circuit executions. In general, the Spectre data processing engine operates on and generates cBase compatible columnar databases, such as the data sets described and used herein. Therefore, any reference to processing one or more data sets with a hospital operations measurement and performance analysis factory circuit may be performed by the Spectre data processing methods and systems described herein and/or incorporated herein by reference. Spectre provides specific benefits to a computer system operating the Spectre data processing engine. One such benefit is improvement of computer performance over prior art data processing engines due to the highly efficient computing technology that Spectre employs. Spectre works directly with columnar data bases such as a cBase, which may be the data set used by the hospital operations measurement and performance analysis factory. Features associated with Spectre, such as a semantic knowledge plan that Spectre references and any other infrastructure on which Spectre is described as operating and/or that Spectre may reference or access in association with processing data sets is also incorporated herein by reference in its entirety. In embodiments one or more of the automatically generated hospital operations measurement and performance analysis factory circuits described herein may represent a Spectre compatible semantic knowledge plan. Additionally, the highly efficient processing mechanisms utilized by Spectre including, for example, query optimization, machine code optimization, and execution may be used in any step of the hospital operations measurement and performance analysis factory circuit generation and execution as appropriate. Further as noted in the documents referenced herein, the data sets, such as columnar data sets, described herein may be structured and/or optimized and/or tailored for efficient processing by a Spectre-like data processing engine. These aspects of the Spectre data processing engine are described here as examples of only some of the benefits and features of applying the Spectre data processing engine to hospital operations measurement and performance analysis factory operations.

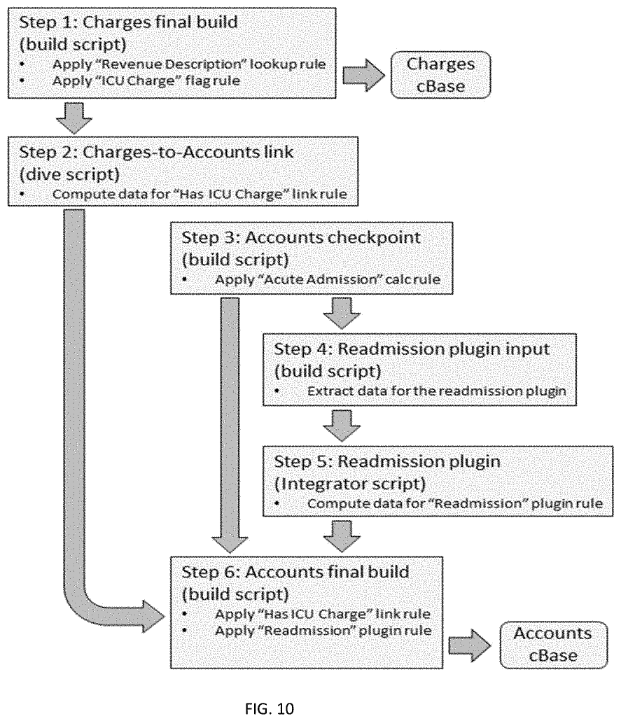

FIG. 10 depicts an hospital operations measurement and performance analysis factory circuit processing flow to produce two cBase compatible data sets, a Charges data set and an Accounts data set, in accordance with embodiments. References to “build circuit” and “dive circuit” may indicate types of Spectre-compatible circuits that may have syntax, structure, formatting, and the like that may benefit from the processing capabilities and optimizations of the Spectre data processing engine. Reference(s) to “integrator circuit” may indicate a circuit that performs an integration process, such as integrating data from multiple data sets and optionally other data sources.

The individual user-defined or predefined factory rules 206 may be combined and/or individually converted, via an automated circuit generation process, into one or more Spectre-compatible circuits, such as a build circuit. The automated circuit generation process will label a circuit as “checkpoint” if it produces an intermediate version of a cBase. Likewise, an automatically generated circuit that produces a final version of a cBase file may be labelled as “final”. These labels, while useful for human inspection of circuits, may have no actionable attributes. On the other hand, during processing of a data set, any circuit that is labelled “checkpoint” will be processed by a Spectre-like data processing engine before processing a circuit labelled “final” to ensure proper integrity of the resulting data sets.

The Spectre technology may employ a combination of Spectre-compatible circuits for executing some factory rules 206, such as a link rule. In an example, of multi-circuit link rule processing, a dive-like circuit may be processed to summarize data from a matching data set (e.g., a data set that may have multiple records for each unique record in an origin data set). This dive-like circuit execution may be followed by execution of a build-like Spectre compatible circuit that joins the summarized data from the matching data set into the corresponding records in the origin data set.

The hospital operations measurement and performance analysis factory methods and systems may further improve computer performance by selectively eliminating certain calc output data columns from resulting cBase data sets. In general, a hospital operations measurement and performance analysis factory produced cBase data set will include a column for each rule processed during the factory operation on the data set. Generally, a cBase data set produced by a hospital operations measurement and performance analysis factory execution will include the same number of records (e.g., rows) but more columns that the original source data set before being processed by the hospital operations measurement and performance analysis factory. However, calc factory rules 206 that were not used by any other rule type are removed from the final cBase file; however, the continue to be saved and processed at query time. This reduces memory requirements for storing and processing resulting cBases. It also improves data query performance by a combination of smaller data bases and use of the Spectre data processing engine's highly efficient columnar database processing capabilities. Performing a calc factory rule 206 with a Spectre data processing engine at the time the data is needed results in an improvement in overall computer performance rather than increasing the size of the resulting cBase to store the data for such calc rules.

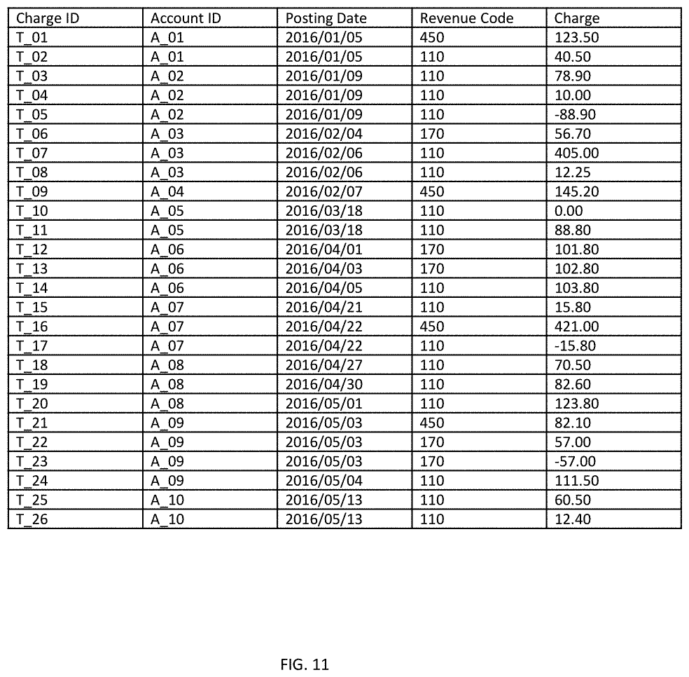

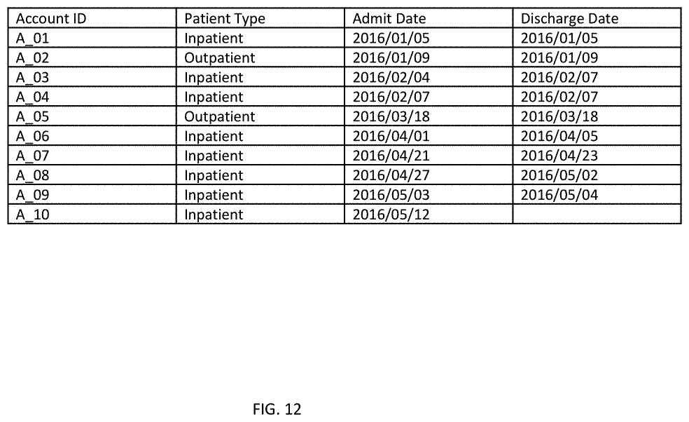

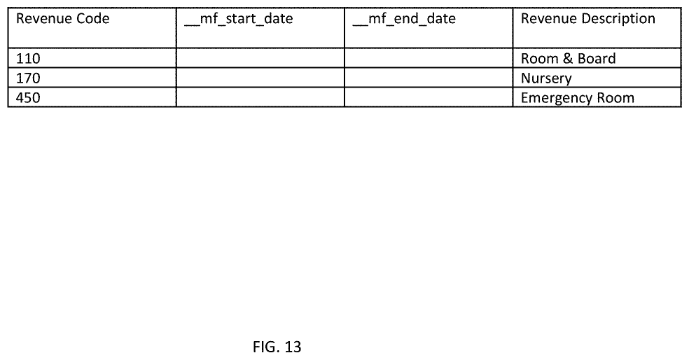

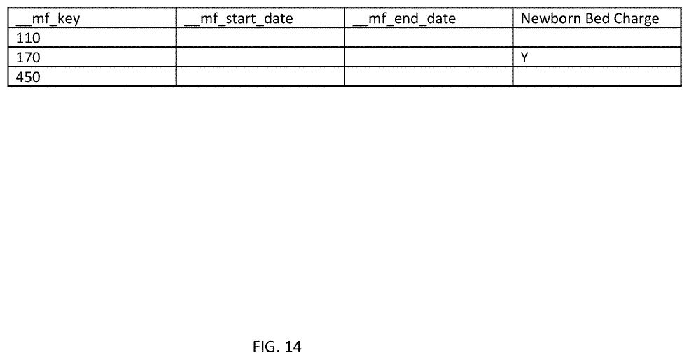

FIGS. 11-14, depict hospital operations measurement and performance analysis factory data set tables from an example use of the hospital operations measurement and performance analysis factory methods and systems described herein. FIG. 11 depicts a hospital operations measurement and performance analysis factory source data set for charges associated with transactions of a business, such as a hospital. The charges data set of FIG. 11 includes several source rules that are depicted as column headings in this columnar data set including Charge ID, Account ID, Posting Date, Revenue Code, and Charge. FIG. 12 depicts a hospital operations measurement and performance analysis factory accounts data set. This data set includes rules for Account ID, Patient Type, Admit Date, and Discharge Date. FIG. 13 depicts an example lookup rule reference file that may be used to add a Revenue Description to another data set, such as the Charges data set of FIG. 11. In the table of FIG. 13, Revenue Descriptions may be established with an effectivity time-frame that may be defined by dates entered in the_mf_start_date and_mf_end_date columns for each entry. FIG. 14 depicts an example flag rule table for determining which charges in the Charges data set of FIG. 11 are Newborn Bed Charges. In this example, Revenue Code may be used as a flag key. Charges with revenue code of 170 will be flagged as being a Newborn Bed Charge. Other revenue codes (e.g., 110 and 450) do not get flagged as Newborn Bed Charges in the Charges data set.

Hospital operations measurement and performance analysis factory methods and systems also include automatically generating data processing circuits based on user configured source files and factory rules 206. One potential approach for converting factory rules 206 into circuits may include determining which data sets have the data required for executing each factory rule. Additionally, each factory rule 206 may be evaluated to determine what data it will produce in each data set. If a factory rule 206 generates a type of data that is not available in any source data set, but that is required by another factory rule, a dependency between the factory rules 206 may be automatically established. This may be accomplished by generating a graph of where data for each factory rule 206 comes from, what data needs to be populated in each data set, and what data needs to be present for generating final measures to be presented in a user interface, such as a dashboard of business performance measures, and the like. Optimization of all data paths throughout the execution of the hospital operations measurement and performance analysis factory instance is not necessary due to the highly efficient Spectre cBase processing technology that is used to execute the generated circuits. Any given set of hospital operations measurement and performance analysis factory data sets may be processed dozens of times (perhaps 50 or more in some instances) through the execution of automatically generated hospital operations measurement and performance analysis factory circuits. The tradeoff of simplicity of user factory rule 206 definition and circuit generation is worthwhile because of the efficiency of the Spectre data processing engine.

Configuring a hospital operations measurement and performance analysis factory may further include identifying the types of data to be presented in a user interface, dashboard, guided page and the like. Factory rules 206, source rules, dimensions of the data, and the like may be identified. These aspects may be used as a guide to generation of final cBase data sets that will be used by the user interfaces, and the like.

Configuring a hospital operations measurement and performance analysis factory may further include identifying trends for measures that may be positive or negative. By defining a trend as positive, a dashboard for presenting measures corresponding to the trend may include an indicator that reflects the trend as positive or negative, rather than just as a numeric value. Referring again to FIG. 1, dashboard 110 presents measures as graphics that can reflect a value of a measure on a scale of measure values. Measure 112, for example, may include a variety of ranges for measures that can depict whether the measure represents a positive, neutral, or negative trend.

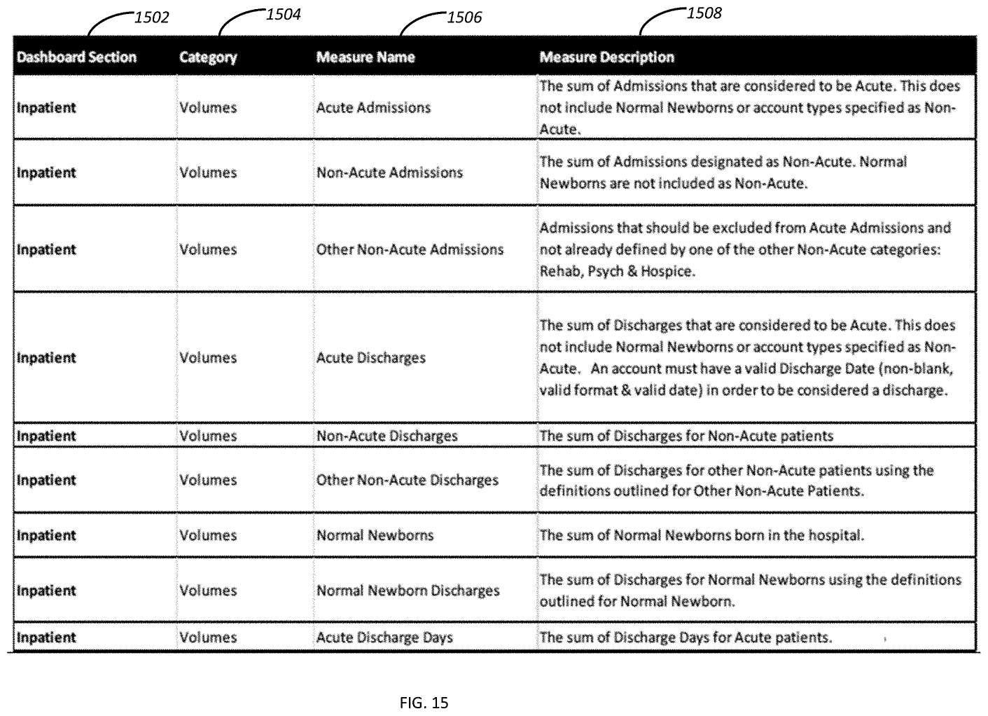

Referring to FIG. 15 that depicts a table that represents measure configuration and description information, various Inpatient measures for hospital operations are defined. Each measure may be associated with a portion of one or more hospital operations measurement and performance analysis factory dashboards as shown in the dashboards section 1502. Likewise, each measure may be associated with a category 1504. For convenient reference, each measure may be given a measure name 1506. A measure description 1508 may be included to provide a business-centric description of each measure that can be turned into a set of factory rules 206 during a hospital operations measurement and performance analysis factory configuration process.

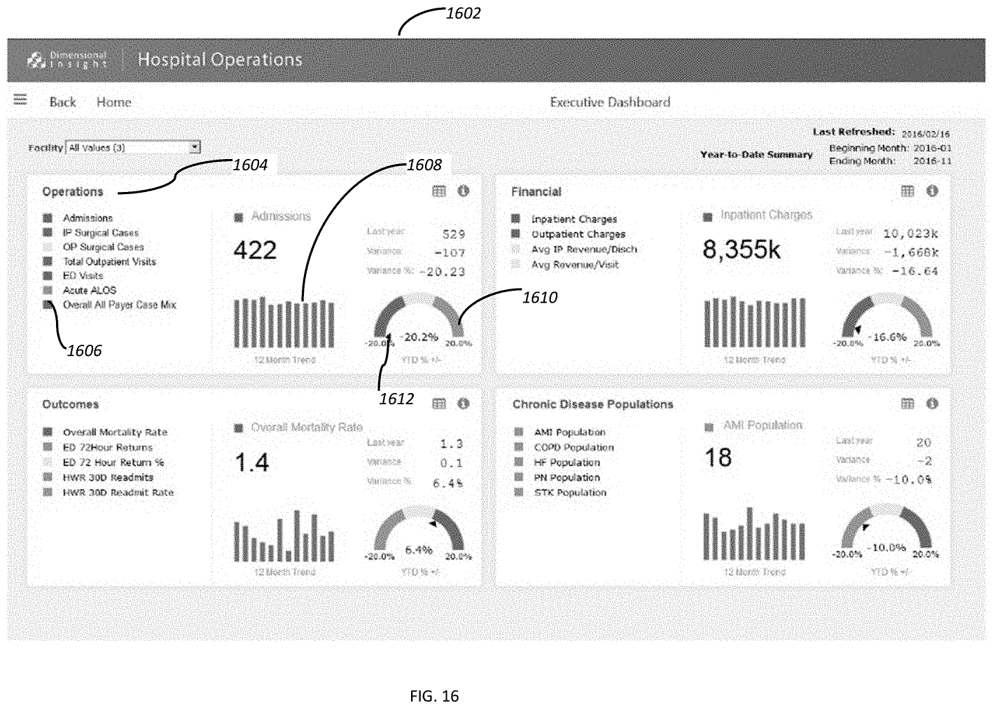

Referring to FIG. 16 that depicts a hospital operations measurement and performance analysis factory executive dashboard 1602 that provides information for a plurality of measures and with comparisons over various time frames. In the dashboard embodiment of FIG. 16, measures are presented in four categories 1604 with individual trend visual indications 1606, including color coding, such as green for changes over time that fit a preferred trend and red when a measure is following a trend that is not preferred. Additionally, data for a number of time frames 1608 and a visual indicator of the trend of the measure on a trend scale 1610. Measure configuration information and hospital operations measurement and performance analysis factory output data is referenced when generating such a dashboard. An indicator 1612 on the trend scale 1610 is automatically generated based on this information.

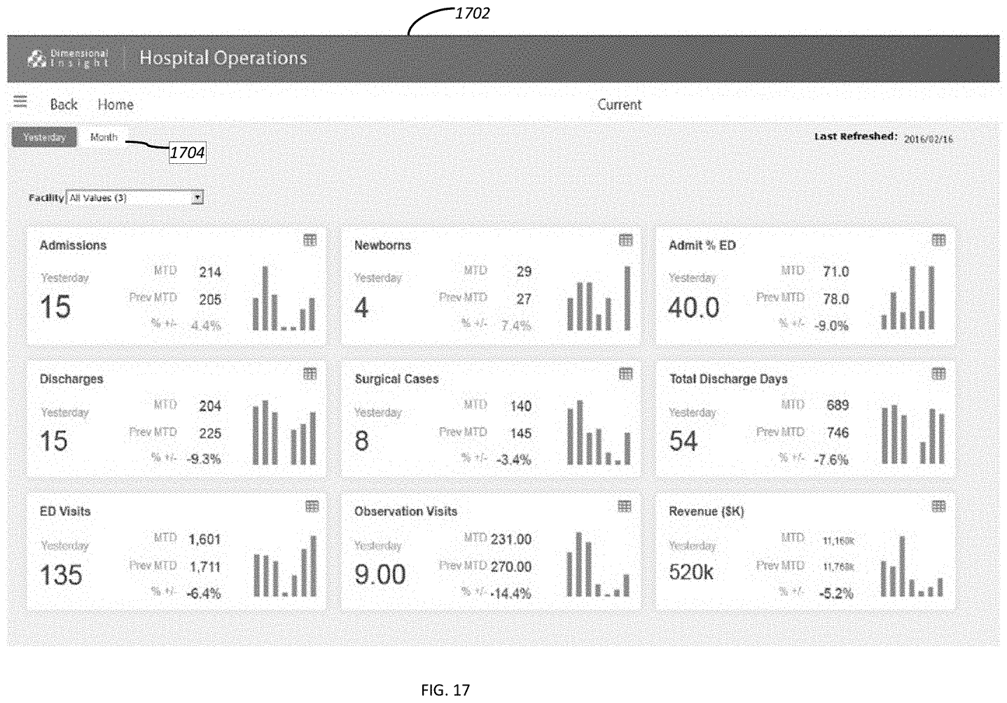

Referring to FIG. 17 that depicts a current dashboard 1702 in a user interface of a hospital operations measurement and performance analysis factory for measures based on recent time periods, a current period is presented in bar graph form. The example dashboard of FIG. 17 shows nine measures for a single day time period (yesterday) 1704.

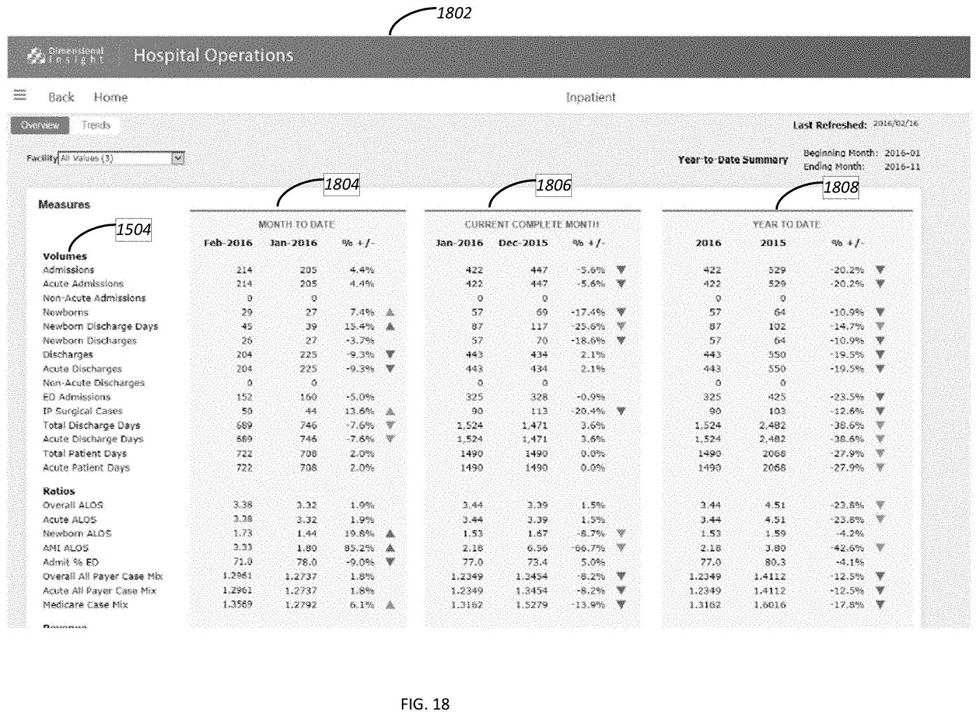

Referring to FIG. 18 that depicts an inpatient table 1802 of measures in a hospital operations measurement and performance analysis factory user interface, a scrollable table includes measures grouped by measure category 1504 for a range of time frames, month to date 1804, current month 1806, and year to date 1808.

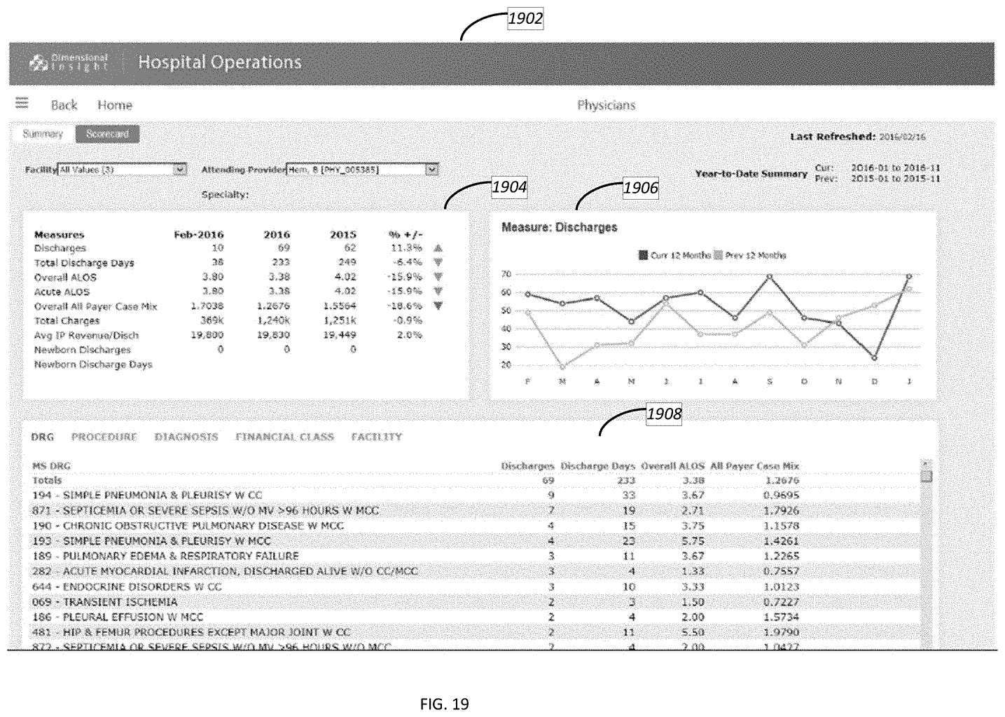

Referring to FIG. 19 that depicts a multi-view dashboard 1902 in a hospital operations measurement and performance analysis factory user interface, several measures for a selected physician are shown in table form 1904, line graph form 1906, and broken down by diagnosis 1908.

Methods and systems for new and novel applications of a hospital operations measurement and performance analysis factory may include automated detection of differences of business-specific performance measures via automated computation of measures by applying source rules and factory rules 206 to business-specific data. The differences may be automatically detected by comparing measures to normalized measures of the same type to identify departures from normal. The normalized measures may be established based on historical averages. They may also be established based on past time periods.

Automated detection of differences and suggestions for sources of data that contribute to the detected differences may be accomplished through a combination of applying the source rules and factory rules 206 as described herein to generate measures that are automatically generated from a user description of the measure, and using a data diving engine that can process the underlying definition and automated circuits that produced the measure to form a structured definition of the measure that identifies the source data, intermediately generated data, and final measures. By processing the elements that make up the hospital operations measurement and performance analysis factory, the data diving engine can pinpoint sources of measures through several iterations of computation. These sources may be original source data files, content added to the source files during hospital operations measurement and performance analysis factory execution, and the like. With this knowledge of the elements and hospital operations measurement and performance analysis factory operations that contribute to the production of measures of business performance, the data dive engine or the like can work through elements to find candidates for explaining the differences in two measures, such as a measure output for two or more time periods (e.g., current period and an earlier period).

As a data dive engine processes the actions that make up the measure of business performance it may arrange the underlying data sources so that those with a greater likelihood of contributing to the difference receive a higher rating as representing a cause of the difference. This may be done through comparing comparable source data for the two measures. As an example, if a measure of a current period is detected as substantively different from a prior period, each data value from the two time periods that contributes to the measure of the two periods may be individually compared.

Merely comparing each pair of data elements could be inefficient and may further result in many candidates. Techniques that target more likely sources of difference may be employed, such as traversing through the computations from the resulting measure backward through the computations, such as by following the circuit that generated the measure in reverse.

Another approach for detecting candidate sources that impact business performance as determined by comparing two hospital operations measurement and performance analysis factory measure while reducing the computing resources required for this analysis may be to compare values for these time differences while processing the values to generate the final measure. Each difference above a threshold (e.g., a percent change and the like) could be flagged or otherwise logged as a potential candidate. Likewise, as each factory rule 206 computation is performed by the hospital operations measurement and performance analysis factory, the new rule value may be compared for a range of time periods. New rule values that exceed a threshold can likewise be flagged.

Because a hospital operations measurement and performance analysis factory may produce many measures for many different time frames trending may be calculated as part of the hospital operations measurement and performance analysis factory operation. In an example, a factory rule 206 may be configured to generate a trend indicator or quantitative value in data records for later time frames based on data or similar indicators in data records for an earlier time frame. Another way to optimize analysis may be to compare typical time frames, such as month over month, current month to the same month in the prior year, year to date versus same period prior year, and the like.

When a difference between data used to calculate measures is deemed to be likely to be a significant contributor to the end measure differences, it may be captured or marked for further processing. As an example, a loop-type hospital operations measurement and performance analysis factory rule 206 may be used to produce an extended description or other relevant details about the contributing elements. This information may be made available to a dashboard or other output data structure to be presented in an electronic user interface that may facilitate human analysis of the differences.

A data analysis engine for automating detection of differences in measures of business performance may rely on hospital operations measurement and performance analysis factory technology, such as measures that are defined in a hospital operations measurement and performance analysis factory so that relationship among the measures (e.g., sums, ratios, and the like) may be fully defined. Through this definition, all data sources and outputs are setup to allow automated calculation of any measure. By automating a data analysis process, it may be possible to access for analysis and/or presenting in a user interface any underlying detail. The analysis may be characterized by techniques that identify things of interest, such as by detecting large changes period-to-period or departures from detectable patterns and the like. The analysis methods may further automatically identify contributors to the things of interest and present them with relevant context, such as “This is the highest contributor, with a confidence factor of ‘x’. This is the next highest contributor, with a confidence factor of ‘y’.” The result could be presented in an executive dashboard that is configurable based on the measures and detected differences so that the candidate sources with greatest impact may be made most visible to the user. Alternatively, the dashboard could be configured so that information presented could be based on the user's role (e.g., a financial person looking at the sources of differences versus a line manager looking at the sources of the differences).

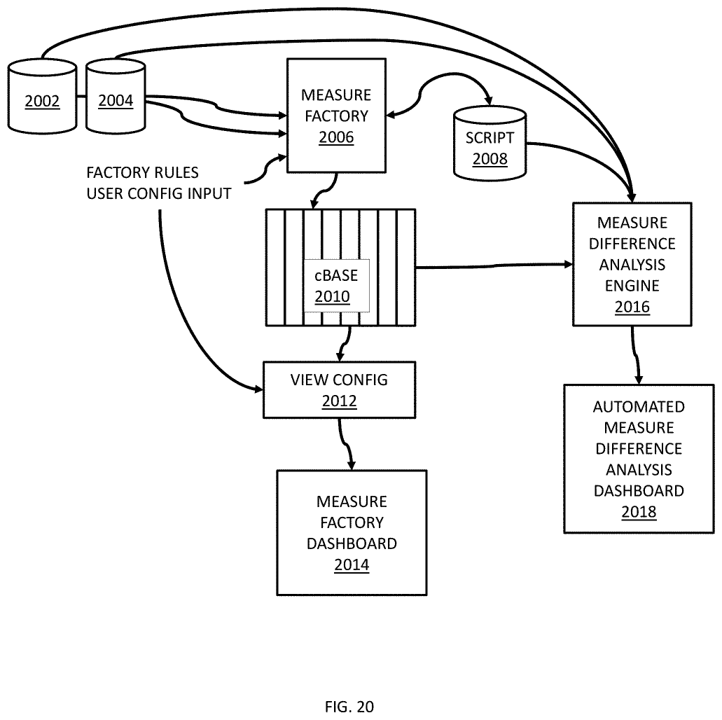

Referring now to FIG. 20 that depicts a diagram of systems elements for measure difference automated analysis. Data sources 2002 and 2004 may be input to a hospital operations measurement and performance analysis factory 2006 and processed according to factory rules 206 and user configuration input that have been transformed by the methods and systems described herein to a hospital operations measurement and performance analysis factory circuit 2008. The hospital operations measurement and performance analysis factory 2006 produces a columnar database cBase 2010 that may include one or more rules (e.g., columns) that contain difference impact indicators for rows of data. As described herein, these indicators may be generated by the hospital operations measurement and performance analysis factory while processing the source data to produce measures. The user configuration information may be used to produce a view 2012 of the cBase 2010 that results in a hospital operations measurement and performance analysis factory dashboard 2014. A measure difference automated analysis engine 2016 may process the cBase 2010 along with the circuit 2008 and source data 2002 and/or 2004 as described herein to produce an automated measure difference analysis dashboard 2018 as described herein.

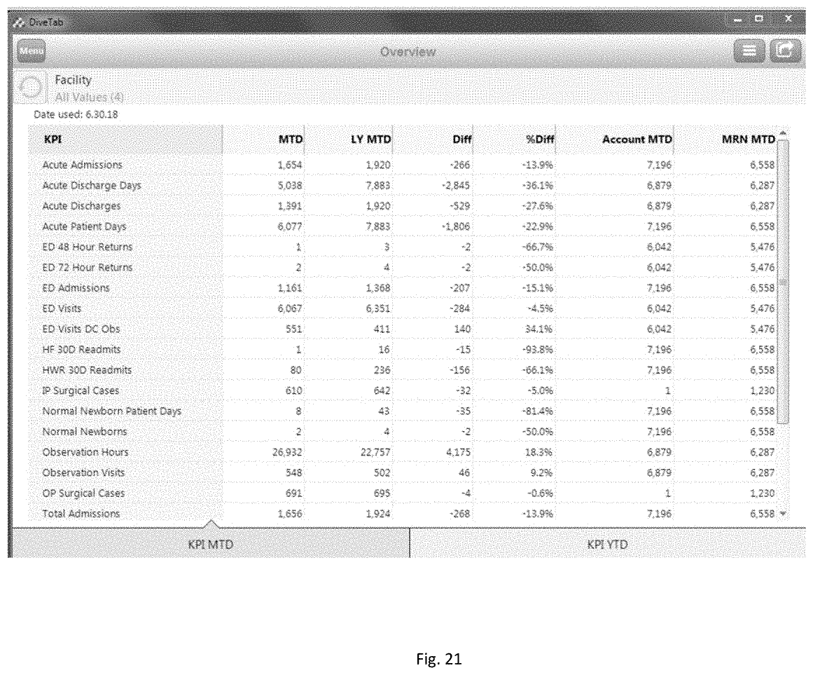

Referring to FIG. 21, which depicts embodiments of an overview-type page of a plurality of guided pages for operating a hospital system and discovery of sources of measures, such as KPIs and the like that represent performance of operational aspects of a hospital system and/or any individual facility (e.g., individual hospital) structured into an operating entity, such as a hospital group and the like. In embodiments, FIG. 21 depicts KPI data that reflects operations of a hospital group including four hospitals, which are referred to in the embodiments of FIG. 21 as Facilities. The overview page of FIG. 21 presents time-based measures (e.g., Month-To-Date (MTD), and the like) for a current year, a prior year (LY MTD) and calculated data representing one or more relationships among the data presented. In particular, the overview page of FIG. 21 presents, among other things, values for a large number of KPIs for the presented units of time (MTD, LY-MTD, and the like).

Throughout the figures described herein, a hospital system is used as an example source of operations data from which KPIs are produced, such as with a measures factory and the like described in Exhibit A and others. The example hospital system used herein includes four facilities, which may be hospitals or other independently operating facilities. Each facility (e.g., individual hospital) may be structured to perform operations that are substantially like other facilities while maintaining a separate management structure. Therefore, selecting, for example, one of the four facilities may limit data presented in a generated page to KPIs that reflect the selected facility.

Referring again to FIG. 21, embodiments of a table of interactive entries includes a set of entries in a first column, representing row headings, indicate a plurality of KPIs that are calculated with a measures factory for operational data in the hospital system. The table includes entries in a first row, representing column headings of calculated KPI (e.g., measure) values for KPIs presented in the first column. Entries in the intersecting cells represent time-specific measures of each calculated KPI. As an example, the first row of KPI values reflect month-to-date, last year month-to-date, and difference data, among other things for an Acute Admissions KPI.

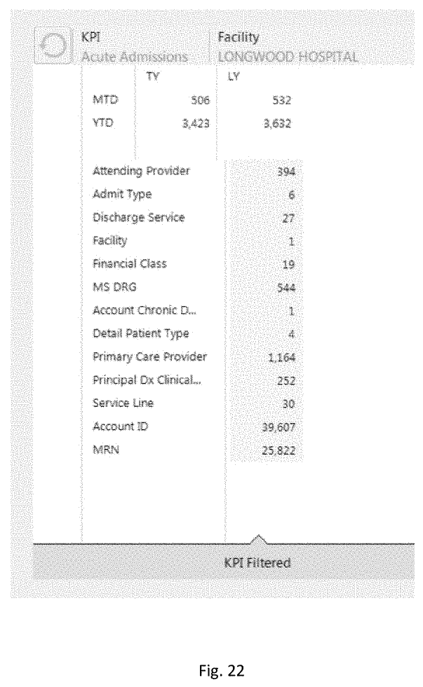

Referring to FIG. 22, embodiments of a table of entries may be presented based on a selection in the table of FIG. 21 of one of the facilities and one of the KPIs, specifically Acute Admissions for Longwood Hospital facility. This list page shows details of values used to calculate the acute admissions KPI for such admissions in Longwood hospital. Data types and values used to calculate this KPI include attending physician, admission type, discharge service, and others. Therefore, for the total of acute admissions in a specific time period, here the period is month-to-date, further details are presented for these additional domains.

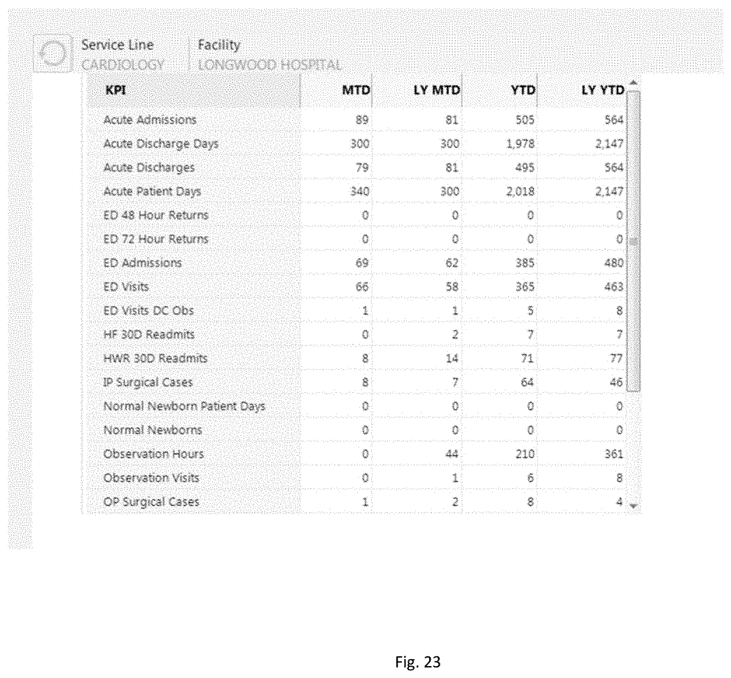

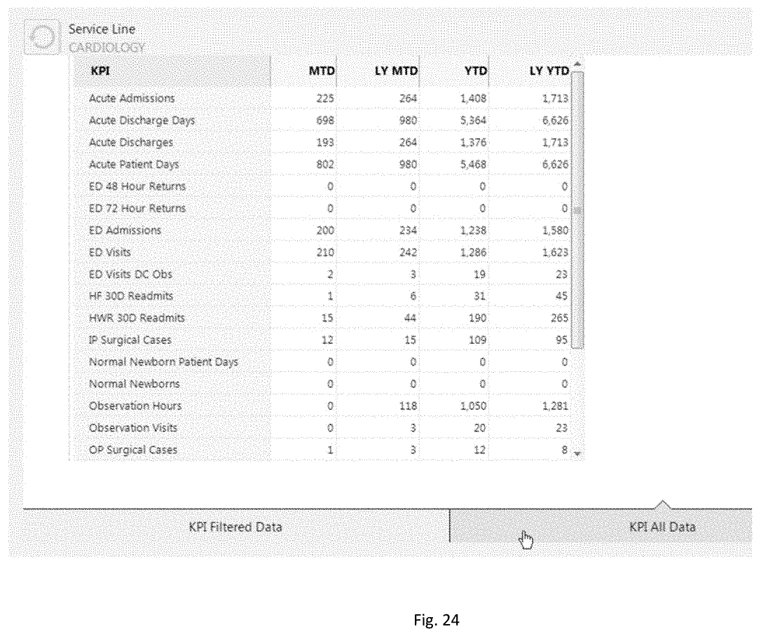

Referring to FIG. 23, embodiments of a table of entries for a specific service line dimension one of the four facilities, Longwood Hospital, is presented. Here, service line cardiology may represent a dimension that is common to each of the four facilities and for each of the KPIs. This commonality of dimension is reflected further in FIG. 24 that depicts KPI data for the cardiology service line dimension across all four of the facilities. As shown in FIG. 23, KPIs for a given facility, service line and the like may be presented in a first tab of a guided page, while all-data KPIs may be available for viewing in a second tab. The methods and systems for generating the content of a page, structuring that content, and presenting it may include generating filtered data (e.g., KPI Filtered Data as shown in FIG. 23) and unfiltered data (e.g., KPI All Data as shown in FIG. 24). In this way, the methods and systems performed when generating KPI and other values for presentation in a guided page associated with a specific dimension value (here the Longwood value of the facility dimension), may include calculating entries for the selected dimension value, any other dimension value (e.g., another facility), and optionally as an aggregation of all such dimension values (here, all four of the facilities combined).

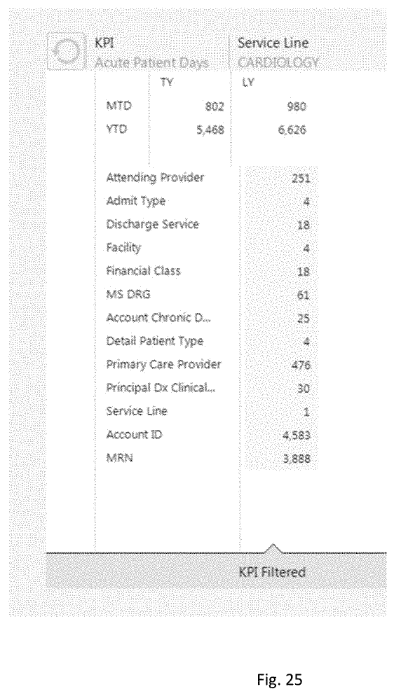

Referring to FIG. 25, embodiments of a table of entries that provide further details about a specific KPI, acute patient days, for the service line dimension value cardiology is presented responsive to a user selection of the Acute patient days in the table of FIG. 24. Here, like in FIG. 22, details of data values that contribute to the KPI are presented. Each row in this table represents domains of data that share a common service line dimension, cardiology. As noted in other embodiments, while the table of FIG. 25 presents filtered KPI data (specifically filtered for the facility Longwood hospital), a tab (not shown) can be selected to present unfiltered KPI data, specifically all Acute Patient Days KPI data from the hospital system.

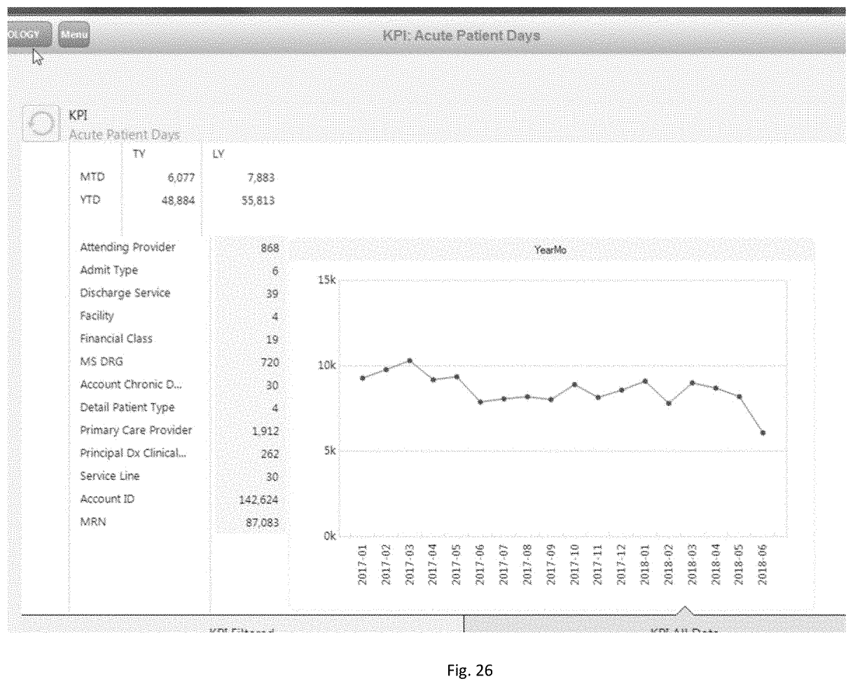

Referring to FIG. 26, embodiments of a time-series (year-month) chart of values for the domain value attending provider is generated when the KPI All data tab of FIG. 25 is selected and the graph function is activated for the data domain Attending Provider.

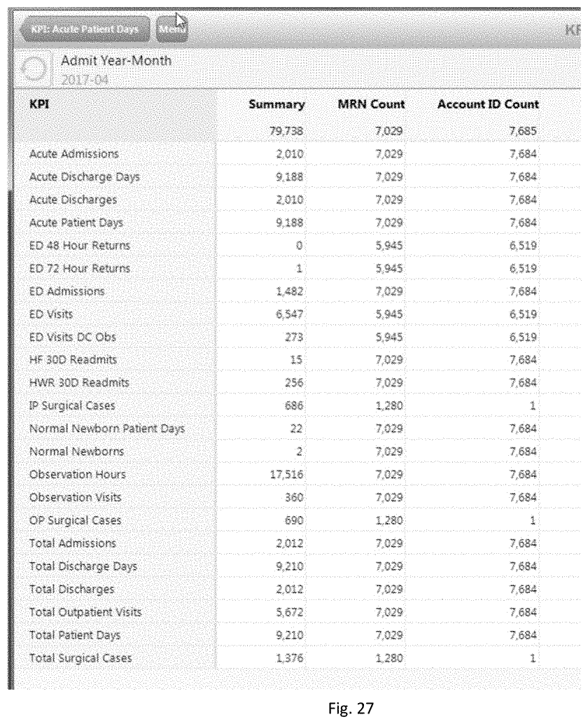

Referring to FIG. 27, embodiments of a list page is presented that shows KPI values for a specific year-month (here it is year 2017, month 04) that was selected in the chart of FIG. 6 by a user selecting the node 2017-04 on the chart.

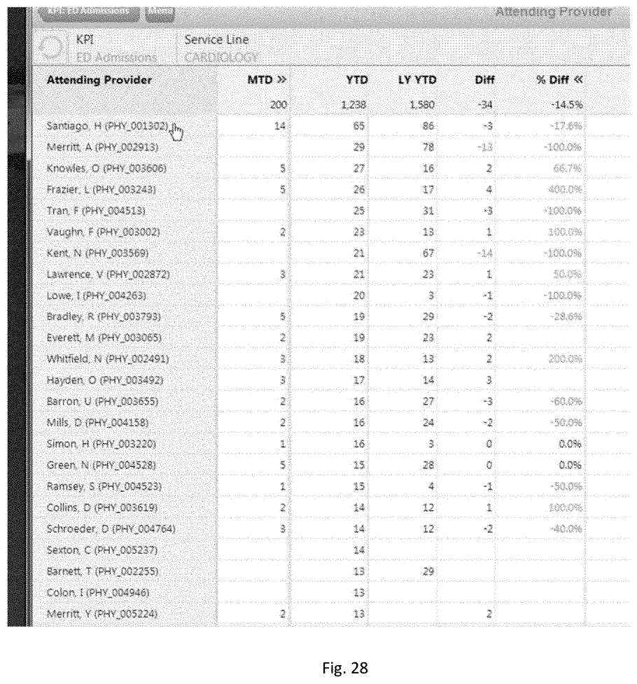

Referring to FIG. 28, embodiments of a page (e.g., a list page and the like) of domain attending provider is presented for the service line dimension value Cardiology as contributed to the KPI Emergency Department (ED) Admissions. While the table of FIG. 8 presents attending providers and their contribution(s) to the Ed Admissions KPI, the table is further limited to ED Admissions that are associated with the service line dimension cardiology.

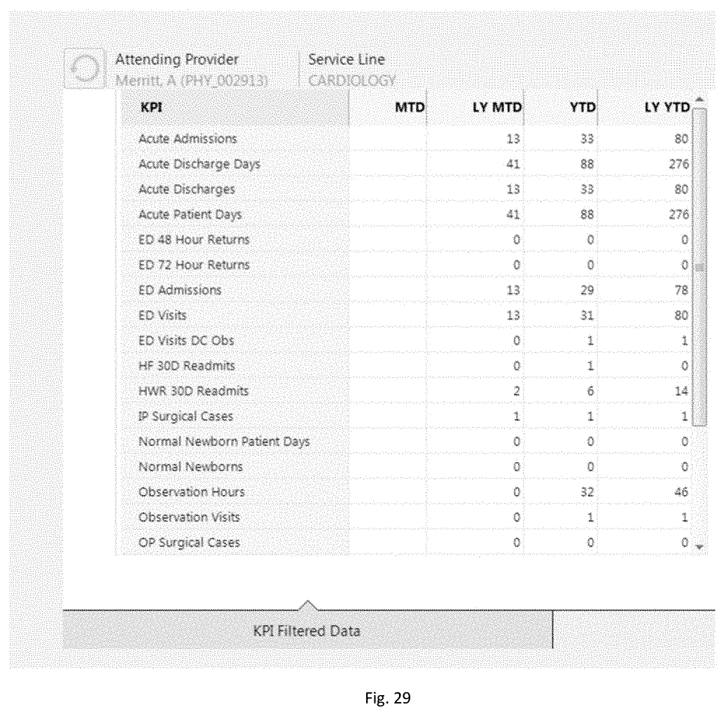

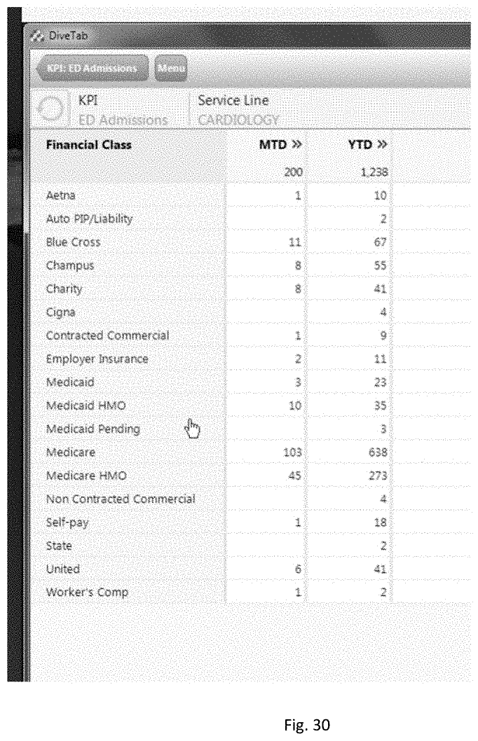

KPIs of any attending provider within the service line dimension cardiology, such as one of the providers presented in the table of FIG. 8 can be presented as show in the table of FIG. 29 responsive to a user selecting a provide in the list of attending providers of FIG. 28. Referring to FIG. 30 that depicts embodiments of details of a financial class data type for ED admissions that contribute to the ED admission KPI services via the service line dimension cardiology.

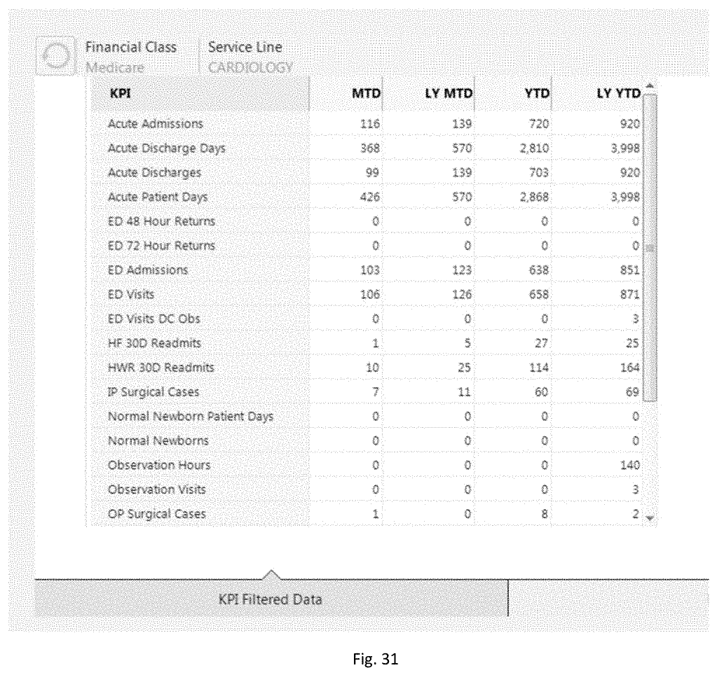

Referring to FIG. 31 that depicts embodiments of a table of KPIs, this time for patients receiving cardiology services (based on the service line dimension cardiology being selected) of a given financial class domain; here the Medicare financial class domain value is presented. The table of FIG. 31 may be produced in response to user selection of the Medicare financial class presented in FIG. 30.

In embodiments, methods, systems, circuits and devices of and about factory measure rendering circuits may be integrated with or into a hospital operations measurement and performance factory to, among other things provide access to measures generated therefrom and to facilitate visualization of measures on small form factor screens. In embodiments, a measure rendering circuit may facilitate producing a set of panels, also referred to herein in the figures for measure rendering circuits filed herewith as items or configured measure views. A measure rendering circuit may be constructed to operate the hospital operations measurement and performance factory to produce any number of panels, each such panel being distinctly configurable, with the measure rendering circuit further providing at least a foundation for organizing the panels into a coherent, inter-related set suitable for rendering on a small form factor screen. In embodiments, a panel, item, configured measure view may depict a set of base view elements that a measure rendering circuit applies to a measure, such as a PKI output from the hospital operations measurement and performance factory for at least rendering in a small form factor screen. Elements in a panel may include fields, variables, links, and the like that may be populated with measure data, or indicia of a measure, such as a link into a dataset produced by the factory, and the like. A panel may further include a plurality of discretely displayable fields associated with a measure that may facilitate comparison of different versions or computations of the measures, such as two different time frames over which the measure is calculated, and the like. In embodiments, other displayable fields associated with a measure may include a comparison field, such as an indication of a difference between measures of the two timeframes, and the like. In embodiments, each displayable field of a measure may be a place holder for a data value associated with the measure, such as an input value, an output value, a calculated result of comparison of the measure, and the like.

A factory measure rendering circuit may further include or indicate, such as by providing a link to or within a data structure including a plurality of panels, items, configured measure views for being presented in a user interface, such as by a display rendering client on a mobile phone.

Measure views may facilitate presenting data from a measure factory. In embodiments, measure views may facilitate pre-configured visualizations of KPI data. For example, a measure view might show three values for a measure (today, yesterday, and the percent-difference), along with an indicator which turns red if the percent-difference value goes below a certain predefined number. A measure view may also display an identifier (e.g., the name) of the measure, and can include an “info” button which can be selected by a user to see more information about the measure.

In embodiments, measure views and a measure rendering circuit enable simple self-service so that users can maintain their own set of KPI pages into which a user can add and remove measure views.

Multiple types of measure views are available to the user, each with its own pre-configured display features. For instance, one view might show a single large number instead of three small ones, or it might show a graph of the values of the measure over the last six months. These view types give the user a level of control over how the measure is displayed, particularly on a small form factor screen. The user does not need to know how to set up the visualizations, they just choose from the available measure view types.

To configure and add a measure view to their self-service page, a user may choose a measure in the factory from a list of measures, such as measures selected by the site administrator for use with a measure rendering circuit to produce a configured measure view. The user may then choose a particular measure view type. A measure rendering circuit may then combine the selected measure with the selected view type to produce a configured measure view and add it to the user's self-service page. The user can change the order of views and remove views.

When displayed on a user's self-service page, the configured measure view can be clicked/touched by the user. In embodiments, clicking at least some visible portions of a configured measure view presented on a small form factor screen may activate, for example, an “analysis” page where the measure data displayed in the view is broken down by one or more dimensions. In embodiments an analysis page so activated may be based on an “ad-hoc” page type, so the user can sort, change dimensions, and dive deeper into the data. The initial state of the analysis page is configured in the measure factory for each measure, so it may show columns that are important for the selected measure.

Another interaction option made available through use of a measure rendering circuit for the user is the “info” button of the configured measure view. Selecting this button may take the user to a page with information about the measure. That information may be automatically generated from the measure definition, such as may be used by the factory to configure and produce the measure. For instance, it may show a description of the measure, the measure's definition, and other metadata such as the format string which trend direction is deemed a good direction (e.g. is it better for the number to go up or down).

These views may be optimized for display on a small form factor rectangular electronic display, such as one found on an IPHONE™, but they are also available on a tablet. Due to the technical focus of a measure view and measuring rendering circuit being on small form factor displays, the measure view may appeal in particular to phone users, because they can use it to get a quick customized snapshot of measures that are important to them, made to fit easily on the phone's small screen.

A measure view type may include a template for a general kind of data visualization which the user can apply to any measure. It may be made up of one or more visual components which are organized and configured to work together. An example advantage of configuring and using a measure view over other visualization tools is that the end-user can apply only a small customization to the template (i.e. choosing the measure) and get a result on the screen, instead of having to make hundreds of configuration. In an example, a user could create portlets and arrange them to look like a measure view or set thereof, but it would require lots of work to set up and position each component. With use of a measure view and the measure rendering circuit, most of the work is done in advance, such as by a skilled user building one or more measure view type configurations.

A user may choose a measure from a list of measures and a measure view type from a list of measure view types; the measure rendering circuit may then combine those selections to produce a configured measure view for populating with a measure factory and presenting on the screen.

A measure view type definition may describe which visual components that appear in the measure view, where they may appear, how they are configured, and how the user's choice of measure applies to the measure view.

Each component in the measure view type has a component type. “Text” is a component type that requests that a measure value be displayed as text. “Text” may also be used to display the measure name, a fixed label such as “YTD:”, and/or other data related to the measure (e.g. a “budget” or “goal” value for the measure, or a value for a related measure). There may also be a variety of indicator component types, including for example “alert”, which displays a circle or other shape filled with a color depending on whether a measure value is performing “well” or “poorly” (based on the “good direction” configured in the Measure Factory for that measure). There may also be a variety of chart component types, including for example “bar chart”.

The position of a component is defined relative to the rectangle that the measure view will use on the screen. A component may be positioned relative to the edges or corners of the rectangle (e.g. top-left, or bottom-center), or it may be positioned in the center of the rectangle. It may also be positioned relative to other components.

Each component type has its own settings, which the measure view type definition must supply. A text component would have settings like font, color, alignment, and padding. For numeric values the text component may specify a format string (which would override the default formatting of a measure value). A bar chart component would have settings like whether a legend is shown, whether the bars are vertically or horizontally oriented, whether tick marks and labels are shown along the vertical and horizontal axes, and so on.

Each component in a measure view type may wish to use in some way the measure selected by the user. For instance, an indicator component may be configured to display a green up-facing arrow if the measure value for the last month was more than 5% higher than the measure value for the month one year prior. A line chart may be configured to display two lines: one showing the values of the measure over the last 12 months, and another showing the prior 12 months. These data configurations are specified in the measure view type definition. The measure view type definition describes how to fetch the data for the component, independent of the measure itself that the user will choose. This data configuration can specify zero or more time ranges (e.g. filter the data to “this year to date”). It can specify time periods to break the data into (e.g. show each month in the range). It can specify other filters to apply (e.g. only show Massachusetts data). It can specify dimensions to break the data into (e.g. show each sales region).

A more complex data configuration option allows a component to display a different measure that is related in some specified way to the measure chosen by the user. The measure factory has a feature called “auxiliary measures”, by which a relationship can be defined between one measure and another. For instance, it can be configured so that every measure in the factory has a “goal” value. The goal is not calculated in the same way as the measure, and in fact different measures can have different ways of computing their goal. In the measure view type definition, we can use the goal of the user's measure. So one might set up the measure view type so that the monthly goals for a measure are plotted alongside the measure's actual values.

A measure rendering circuit may use the measure view type definition and the measure name to produce a configured measure view for display on the user's screen.

First, the measure rendering circuit may need to collect and process the data that will be visualized in the measure view. The measure rendering circuit looks at the components in the measure view type definition, determines what kind of data will be needed to render that component, and produces a measure factory configuration structure, which may be configured as one of a plurality of queries that are processed by the measure factory (e.g., using the columnar data engine described herein).

Second, having collected the data, the measure rendering circuit needs to facilitate a user interface component of a small form factor screen device in rendering the measure view components on the screen. Each component type renders differently. For instance, a “text” component may simply render the requested data as a text string (e.g. “$1,234.50”) as specified by the settings for that component in the measure view type definition.

When a user has multiple measure views, they are arranged on the phone screen in a single column when the phone is in “portrait” mode. In “landscape” mode multiple columns are used. The user can configure the order that the measure views appear, and that order is preserved when switching from portrait to landscape and back.

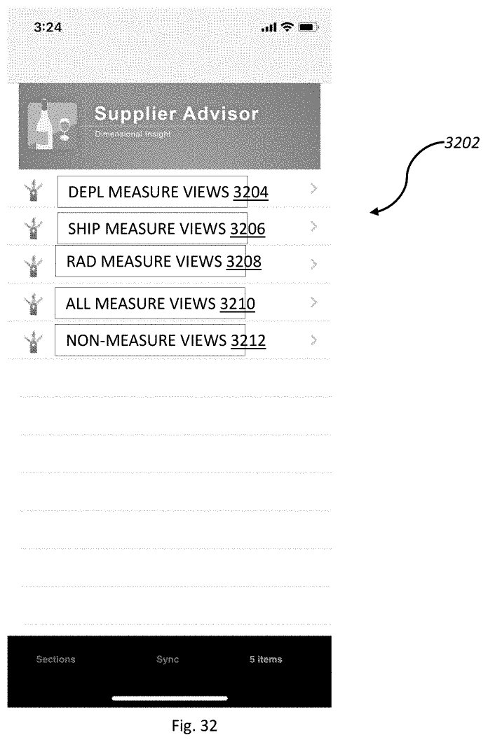

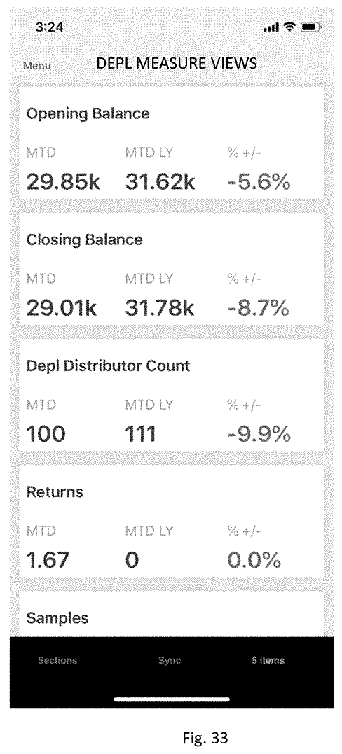

Referring to FIG. 32 that depicts a menu type page 3202 listing measure view pages may provide a user access to configured measure views and to the measure rendering circuit that facilitates producing measures and facilitates rendering them on small form factor screen displays. Each measure view page links to a set of configured measure views that can be displayed using the methods and systems for use of a measure rendering circuit as described herein. In embodiments, each measure view page could be a set of measure view types and linked measures that are packaged and forwarded to the measure rendering circuit when a measure view page is selected such as Depl Measure Views page link 3204. The measure rendering circuit works cooperatively with an instance of the measure factory, such as the hospital operations measurement and performance factory to generate and return the required measure (data) for populating the linked components in the configured measure view type. View pages (collections of measure views) may be associated with specific aspects of a business, such as for this example, depletion view 3204, shipment views 3206, rad view 3208, all measure views 3210, and optionally non-measure views 3212. In embodiments, if a user clicks on Depl Measure views page link 3204, then their screen presents the Depl Measure Views set of measures configured in FIG. 33.

Referring to FIG. 33 that depicts a small form factor screen display in portrait mode of a configured measure rendering circuit, a set of measures for a depletion dimension is rendered. In this example of a measure rendering circuit associated with a set of measures, the display shows a measure rendering circuit produced measure view of balance-related quantities. This measure rendering circuit facilitated view can be vertically scrolled to reveal what is in the “Samples” measure that is partially hidden below the black footer. The black footer shows that there are 5 “items”, which are also referred herein to as individual panels, measure views, and the like. Each visible panel shows two time-frames MTD, MTD Last Year, and % difference. In the embodiment of FIG. 33, each of five panels cover the following measures: (i) opening balance, (ii) closing balance, (iii) distributor count, (iv) returns, and (v) Samples.

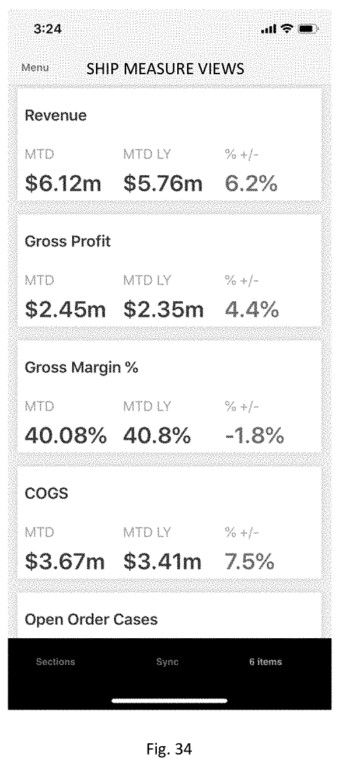

Referring to FIG. 34, that depicts a multi-panel factory measure rendering circuit renderings of several measures for a “shipment” dimension of the data. The small form factor screen display shows a vertically oriented view of the Ship Measures View 3206. While revenue-related measures are presented they cover the same timeframes as the measures in FIG. 33, but for revenue, gross profit, gross margin, cost of goods (COGs), open orders that is partially in view and one other that is not displayed, for a total of six measure views for the Ship Measures View 3206.

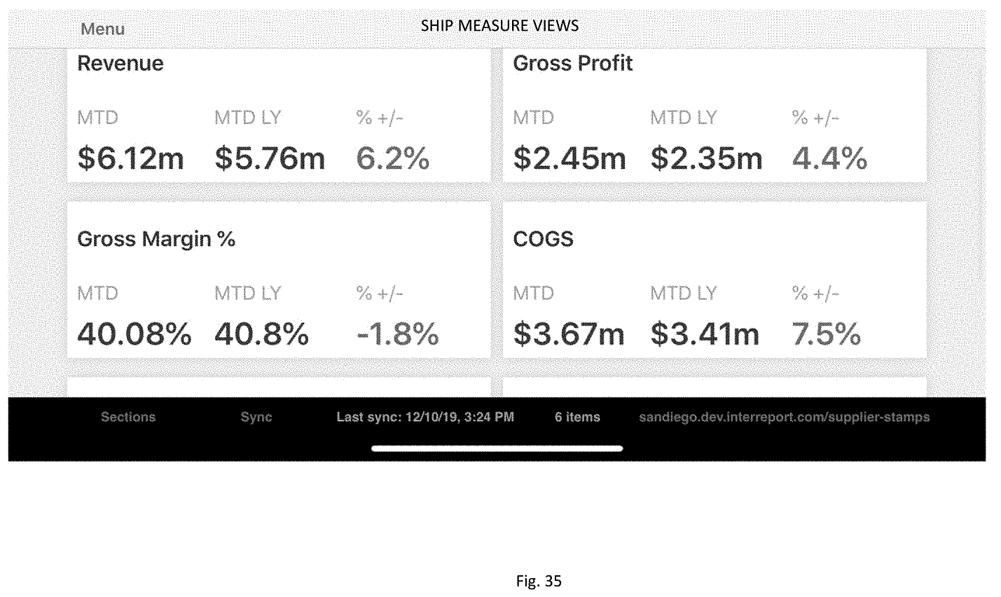

Referring to FIG. 35, a landscape orientation of the measure views of FIG. 34 (e.g., as a result of rotating the small form factor screen device). With a wider screen for presenting the measure rendering circuit panels, one can now see the top of the 5th and 6th panels.

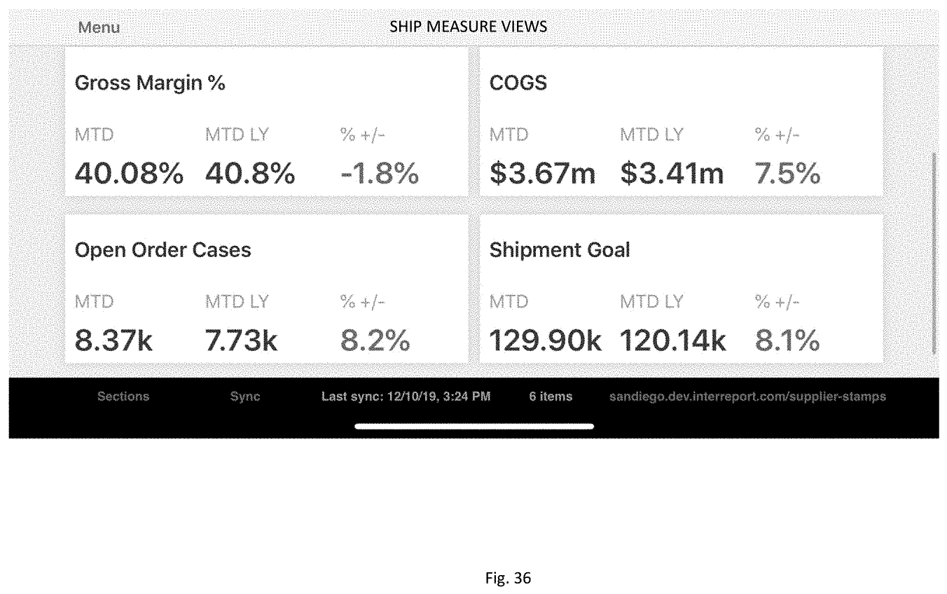

Referring to FIG. 36, the measure views depicted in FIG. 35 has been scrolled up to reveal the 5th and 6th panels (open order and shipment goal).

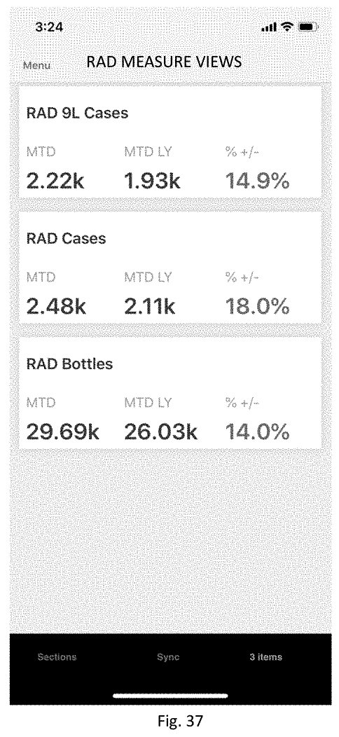

Referring to FIG. 37 that depicts a third multi-panel factory measure rendering circuit rendering of a plurality of measure views on a small form factor screen display in portrait mode. Note that all three panels defined for this third measure rendering circuit are viewable without scrolling. In this embodiment, a set of RAD measure rendering circuit depicts three measures.

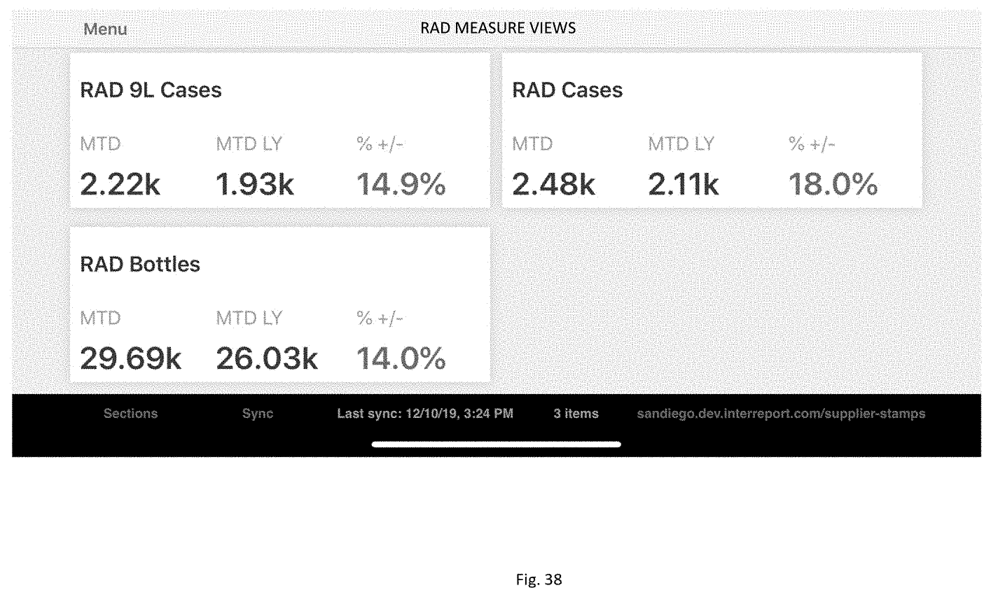

Referring to FIG. 38, a landscape rotated view of the measure view panels of FIG. 37 are depicted.

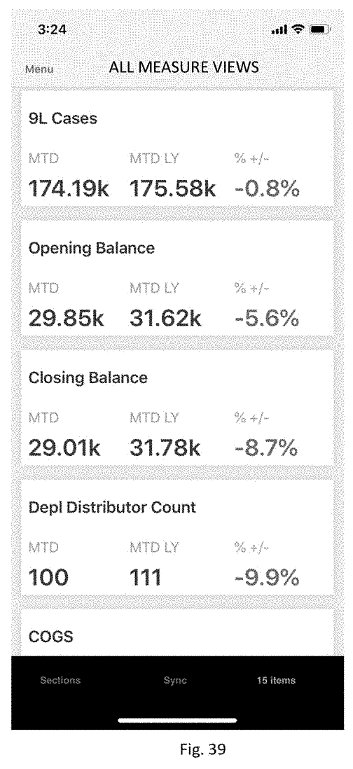

Referring to FIG. 39 that depicts a fourth multi-panel factory measure rendering circuit rendering of a set of measures on a small form factor screen display in portrait mode, this set of measure views is defined in the All measure views page entry 3208 on FIG. 32 that identifies 15 measure views.

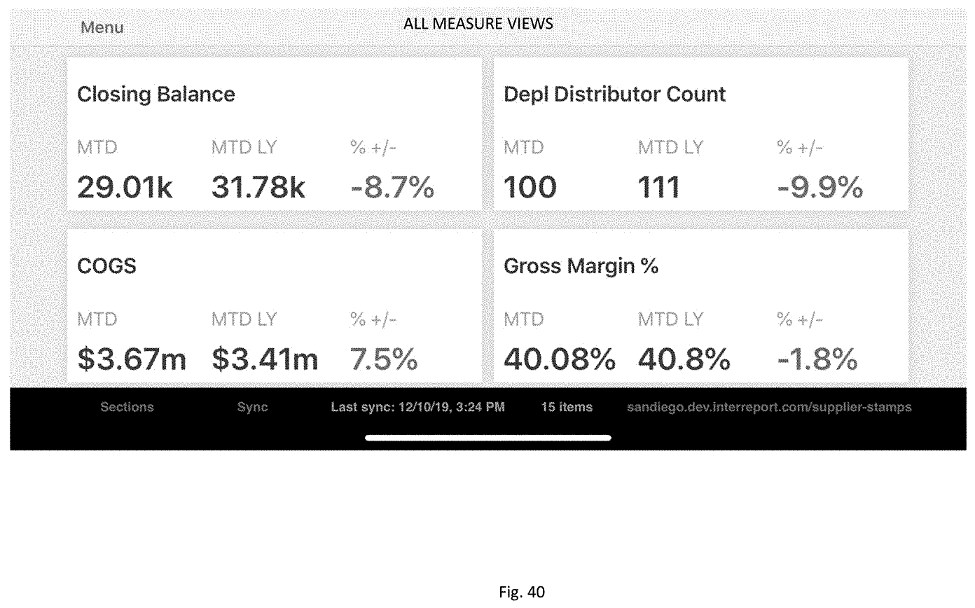

FIG. 40 depicts a landscape rendering on the small form factor screen display of the measure rendering circuit rendering of measures in FIG. 39.

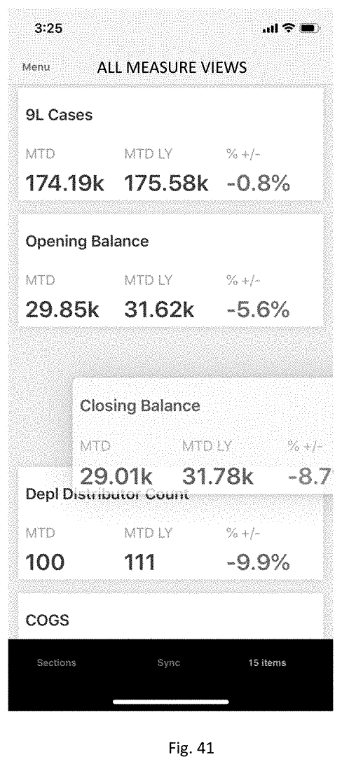

FIG. 41 depicts a user interface screen capability for manipulating individual measure view panels and includes reordering the panels.

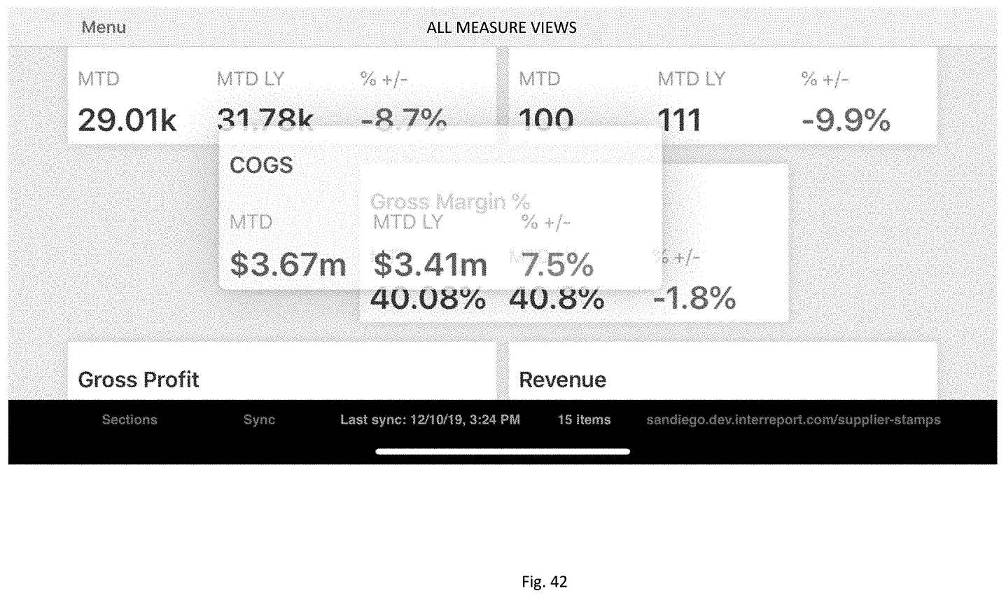

Referring to FIG. 42, a landscape rotated view of the embodiment of FIG. 41.

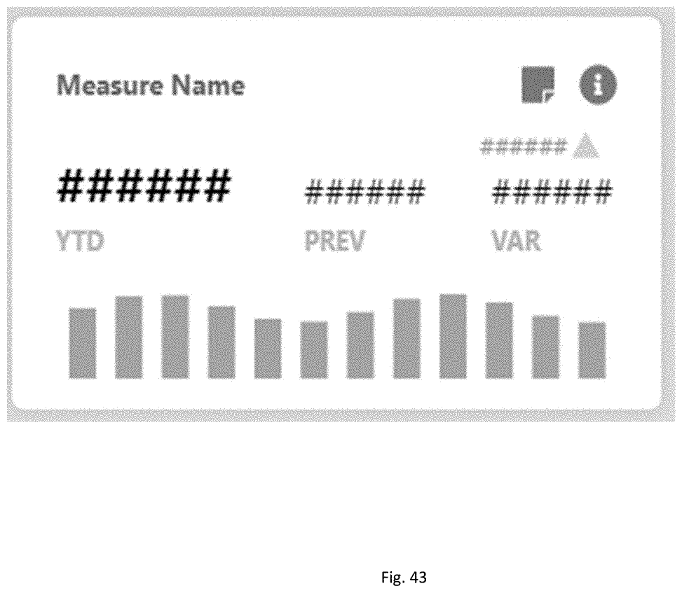

Referring to FIG. 43, a graphical view of a template measure view type is depicted including various types of components, such as bar graph, measure name, information button, trend assessment, measures for two timeframes, variance therebetween, and the like.

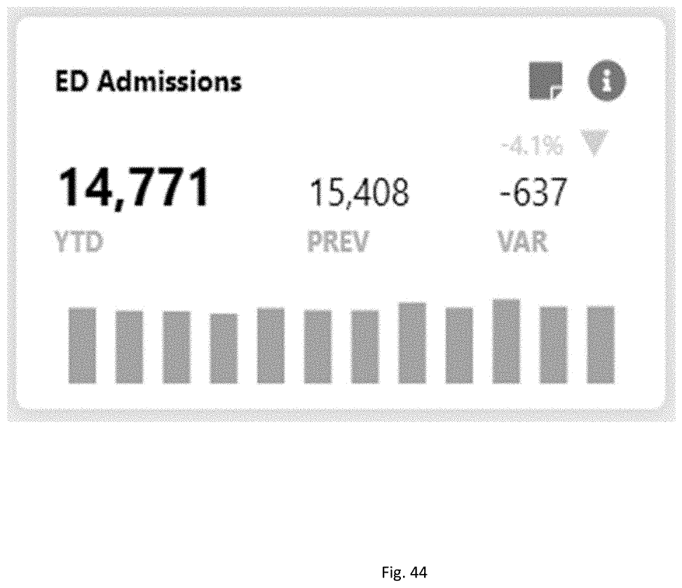

Referring to FIG. 44, an embodiment of a configured measure view of the measure view template of FIG. 43 is depicted, in accordance with embodiments.

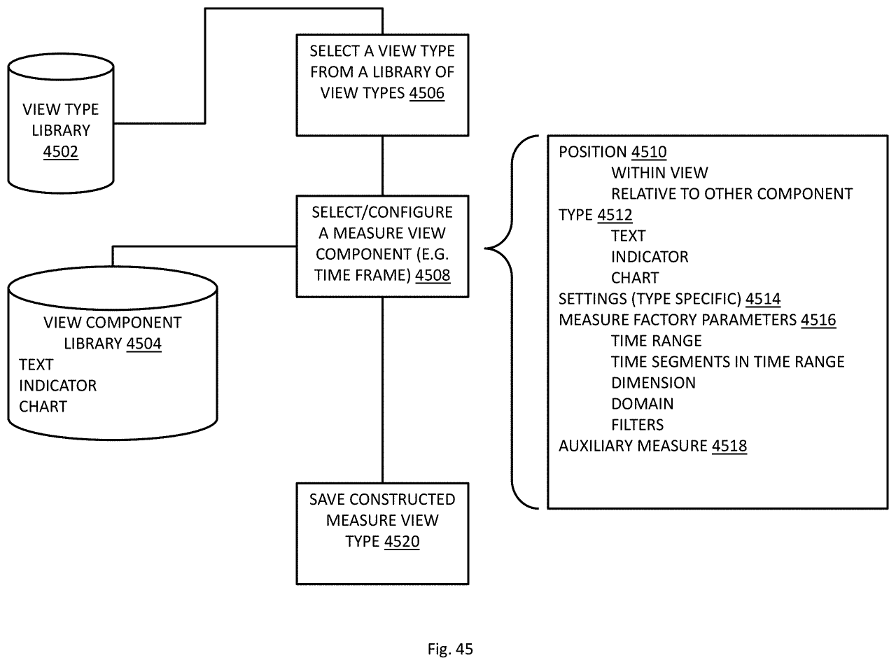

Referring to FIG. 45, a flow diagram depicting an example measure rendering circuit process for constructing a measure view type with components includes data sources such as a view type library 4502 that may include a set of predefined view types and a view component library 4504 that may include various measure view component types, such as text component types, indicator component types, chart component types, and the like. A process step for constructing a view type for use with a measure rendering circuit may include a view type selecting step 4506 which may include selecting a view type from the library of view types. Another process step for constructing a view type may include a component action step 4508 which may include selecting and/or configuring a measure view component of the view type selected in step 4506. Component action step 4508 may include selecting and/or configuring aspects of each component of a view type, such as position 4510, component type 4512, type-specific settings 4514, measure factory parameters 4516 for producing a measure to be used with the view type; auxiliary measure 4518 and the like. Another process step for constructing a view type may include a storing step 4520 that may include saving to a computer memory the selected view type with configured components and relevant component attributes.

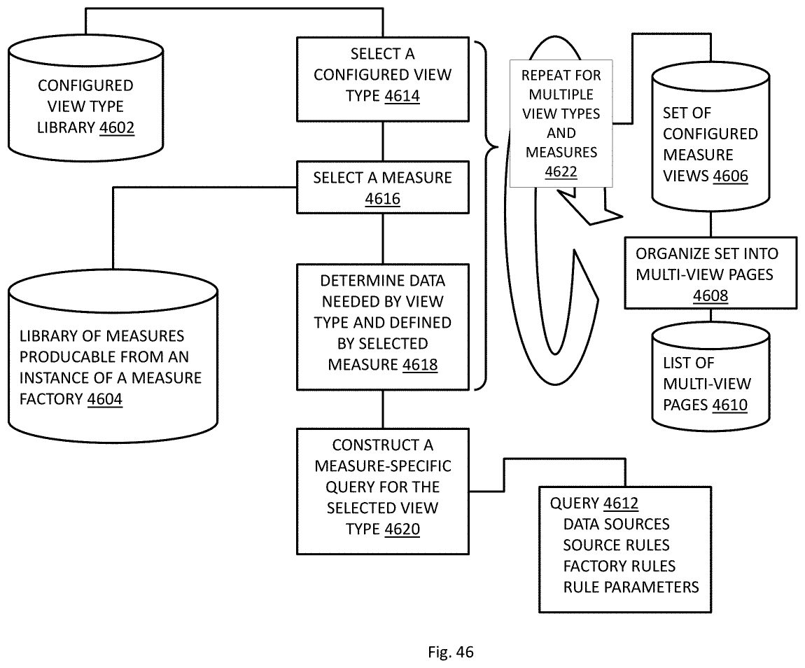

Referring to FIG. 46, which depicts a flow diagram of a process in a measure rendering circuit for aligning selected view types with selected measures for configuring a hospital operations measurement and performance factory measure production data structure and for generating a set of configured views organized into one or more multi-view pages from which a user may select one page for viewing on a small form factor screen and the like. Data sources useful for this flow diagram may include a library of configure view types 4602, a library of measures 4604 producible from an instance of a measure factory, such as the hospital operations measurement and performance factory described herein. Data structures generated may include a set of configured measure views 4606 that can be organized int a displayable list of multi-view pages at process step 4608 to produce a list of multi view pages 4610. Yet additional data structures that may be generated by such a process flow may include a set of measure factory operational parameters 4612 for generating measures to be used for rendering via a corresponding configured measure view. A process for using the data sources (e.g., 4602, 4604) and generating the data structures (e.g., 4606, 4610, and 4612) may include process steps such as, a view type selection step 4614, a measure selection step 4616, a data determination step 4618, and a measure-specific query construction step 4620 that may produce the measure factory operational parameters 4612. The select view type step 4614, select measure step 4616 and data determination step 4618 may be repeated 4622 for a plurality of view types and/or measures to produce the set of configured measure views 4606.

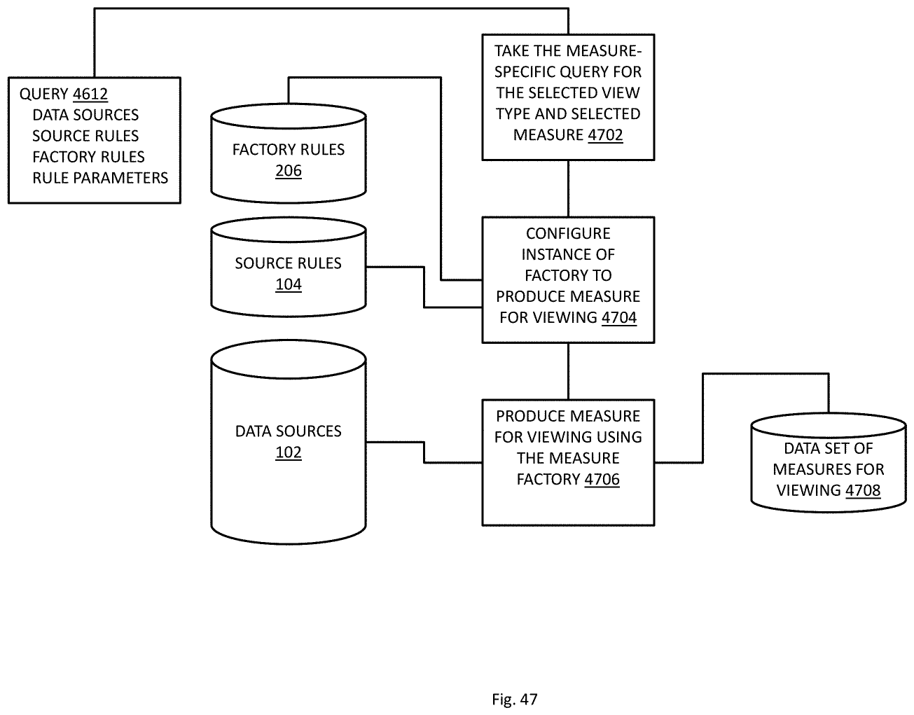

Referring to FIG. 47 that depicts a process of a measure rendering circuit for generating a set of measure data for use with selected view types may include data sources, such as the measure-specific query 4612, factory rules 206, source rules 104, and data sources 102 that correspond to the measure selected in step 4616. The process for generating a set of measure data via a measure factory in association with a measure rendering circuit may produce various data sets including a data set of measures for viewing 4708. The process may include a measure-specific query selection step 4702 in which a measure-specific query is selected from the set of measure specific queries (or just the current measure-specific query if a set is not yet constructed). The selected measure-specific query carries information useful for determining which selected view type and which selected specific measure to produce. An instance of a measure factory, such as the hospital operations measurement and performance factory described herein may be configured in a measure factory configuration step 4704 so that the measure factory instance can produce the measure(s) required for satisfying the measure-specific query 4612. In another step in this measure rendering circuit process, an instance of the measure factory may be executed 4706 to produce measure(s) for viewing based on the selected view type. This step may produce a data set 4708 of measure(s) for viewing.

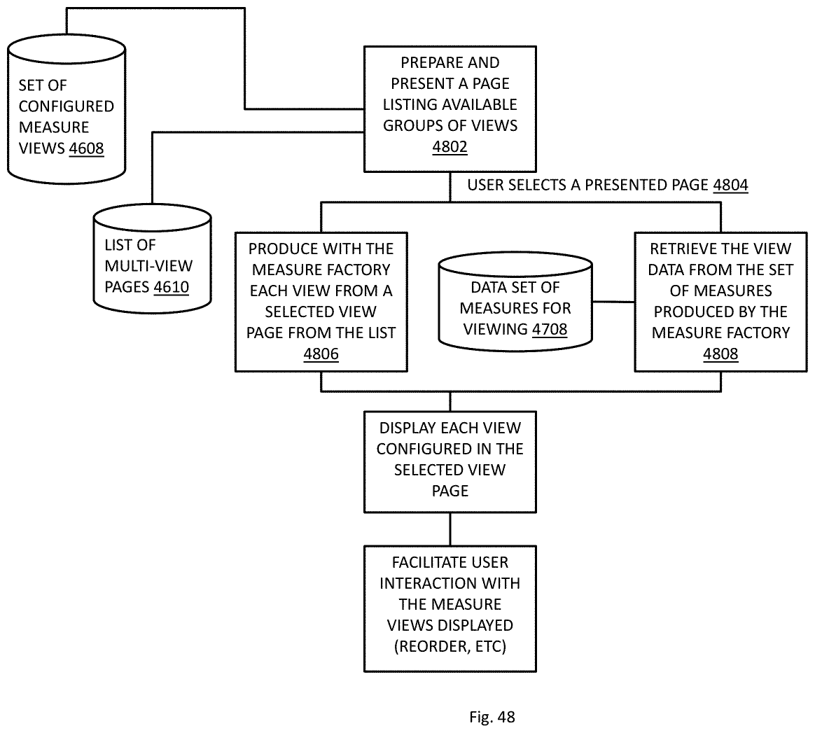

Referring to FIG. 48 that depicts a process flow of a measure rendering circuit for preparing and rendering one or more configured measure views as sets of views known also as self-service KPI pages, data sources used in this process may include a set of configure measure view 4608, a list of multi-view pages 4610, and optionally the data set of measures for viewing 4708. This process flow may include a view group list preparation and display process step 4802 that may access the set of configured measure views 4608 and the list of multi-view pages 4610; assemble the information into a display page of the views; and produce the page for rendering in a digital user interface. In the process a user may select a presented page 4804. The selected page may either kick off execution of an instance of a measure factory to produce each measure for viewing 4806 or a step 4808 to retrieve the configured measure view from the set of measures produced by the measure factory 4708. The measure rendering circuit may further include a display step 4810 in which each view configured in the page selected in step 4804 is displayed. The measure rendering circuit may further include a user interaction process step 4812 in which it facilitate user interaction with any of the measure views presented in the user interface, such as reordering the views and the like.

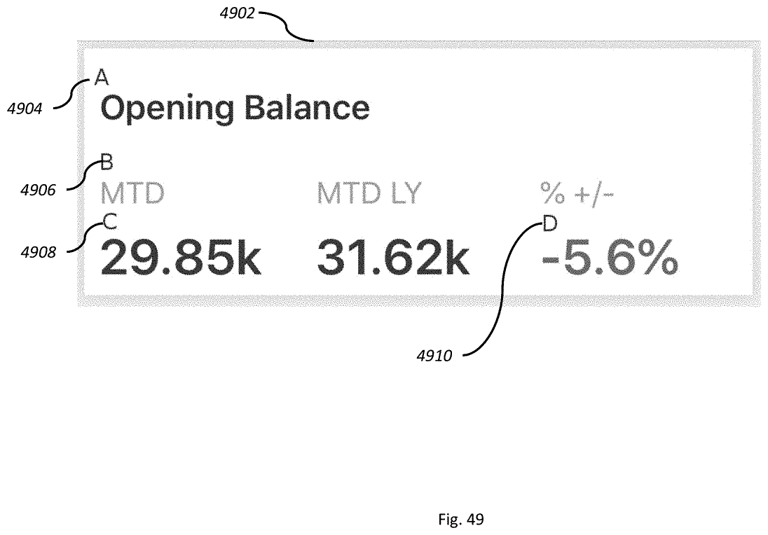

Referring to FIG. 49 that depicts a block diagram 4902 of an example measure view panel as may be presented for rendering measure data produced by a hospital operations measurement and performance factory on a small form factor display may include several components. In this example embodiment, elements A, B, C, and D are depicted:
A 4904: A text component showing the measure name
B 4906: A text component showing the fixed string “MTD”
C 4908: A text component showing the measure's month-to-date value, in thousands
D 4910: A text component showing the percent difference between the measure's month-to-date value and its month-to-date value in the previous year, colored based on the magnitude (“slightly down” in this case)

Embodiments of the present disclosure may include computer-automated disclosure of at least one variance-impacting dimension among a plurality of dimensions of data that contribute to a measure of business performance of business activities that are represented at least in part by the data. As the relevant dimensions of data relevant to a business increase, the potential measures (representing combinations of multiple measures) increase exponentially. Accordingly, no human can possibly evaluate all of the measures that are potentially relevant to a business. As a result of the impossibility of calculating or reviewing even a small fraction of the possible measures, businesses typically define a relatively small subset of common measures, which may or may not reflect important events or trends that are relevant to the business. However, potentially relevant measures can be identified by a computer-automated process that is based on calculated statistics with respect to individual dimensions or facts that are used to generate measures and/or the measures that are created by performing calculations on such measures. Such variances may include variances between defined time periods, variances that are based on some normalization of a measure (such as based on historical calculations of that measure), or the like. In embodiments, detection of a variance may include determining data that contributes to the measure of business activity; comparing differences between at least one of calculations on determined data, summaries of the determined data and elements of the determined data for a plurality of varying (e.g., time-period-specific) measures; ranking at least a plurality of the differences (e.g., from largest to smallest of the plurality of the differences); and presenting at least one of descriptive data for a selected top number of ranked differences and a selected top number of measures with respect to which differences were largest to a user in an electronic user interface of a computer. In embodiments, the user interface may facilitate selecting one more of the plurality of varying (e.g., time-period-specific) measures, such as to obtain further information about the data and/or dimensions that relate to the measure. For example, a business, such as a health care facility, may track many types of information, such as admissions, re-admissions, beds occupied, diagnoses, insurance information, and the like. A measure like occupancy might be reviewed and compared to occupancy for prior time periods, such as the prior week, the same week the preceding year, and the like, and trends might be observed by a human user. However, occupancy of a health care facility may result from a vast array of underlying factors, such as admissions, discharges, diagnoses, births, deaths, and the like, each of which may have a large number of causal factors, such as diseases conditions, economic conditions, environmental conditions, seasonal conditions, and the like. A given level of occupancy may also result in a wide range of financial outcomes for a hospital, as the extent of insurance coverage, the nature of the conditions treated, and other factors can be important. The financial outcomes are similarly multi-dimensional. As a result, looking at a simple measure such as occupancy may provide very little insight into the real business of the operation of a hospital. High occupancy may result in outstanding financial gains, or catastrophic losses, depending on the patient mix. Stable occupancy may indicate a stable environment, or it may be a coincidental result of two opposing trends, such that a change in one of the trends might radically shift the business in a future time period. While a human user cannot possibly evaluate all of the possible causes and effects, a hospital operations measurement and performance analysis factory may, using computer automation, calculate a wide range of potential measures, such as measures involving the contributing elements that result in a higher-level measure like occupancy. Once those measures are calculated, variances (such as over time), of the potentially contributing measures can be used to surface ones that appear unusual, such as possibly reflecting events that bear further analysis. For example, a large increase in the number of patients diagnosed with a serious infectious disease between time periods (e.g., compared week-to-week or for the same week a year before), such as drug-resistant staph infection, would be automatically detected by an automated hospital operations measurement and performance analysis factory generation and variance calculation engine and surfaced to an analyst, even if other measures, such as occupancy rates, remain stable, such as because of favorable trends in other, less threatening diseases.

In embodiments, such methods and systems for automation of a hospital operations measurement and performance analysis factory may include automatically ranking by degree of impact, business-relevant data dimensions and measures that contribute to business measures (and thus may impact a change in business performance), including detecting such dimensions and measures by automated comparison of a plurality of distinct time period-specific measures or dimensions of business performance. Such a process may be applied to the measures generated by processing (such as for a hospital operations measurement and performance analysis factory as disclosed herein) many-dimensional data representing potentially causal factors relating to the activities of a business or other enterprise and/or representing outcomes of such causal factors. In embodiments, processing with a hospital operations measurement and performance analysis factory may further include applying data processing circuits to data representing dimensions relating to business activities or measures, the circuits automatically generated from a plurality of factory rules 206 described as relationships of source rules and relationships of other factory rules 206; a plurality of data sets including data representing the business activities arranged as a columnar array wherein each column is associated with a distinct source rule; and a factory rule 206 execution hierarchy that executes ready factory rules 206 without dependency on other factory rules 206 before executing ready factory rules 206 with dependency on other factory rules 206. In embodiments, a “ready calc” factory rule 206 is applied before other factory rules 206, so that measures that are ready for calculation can proceed, and a ready flag rule is applied after all ready calc rules have been applied to a given data set. Calculation of all ready-for-calculation measures can proceed until all possible calculations are performed. Thus, measures may be serially generated based on readiness for calculation, such that they may be dynamically presented for analysis based on which ones, at a given time, appear to constitute measures of interest, such as based on the variances (e.g., period-over-period) noted above. In embodiments a hierarchy of factory rule 206 execution indicates an order of factory rule 206 execution. In embodiments, the hierarchy may be based in part on the nature of the measures calculated, such as commencing execution on rules that involve measures that have been determined in recent time periods to include dimensions of interest (such as involving significant variances that may reflect business-relevant events). In embodiments, the order of factory rule 206 execution may respond to a ready-for-calculation flag and may lookup such rules to execute before executing “ready link” rules, which in turn may execute before “ready plugin” rules. In embodiments, factory rules 206 that apply only to data within a specific data set may be executed independently of factory rules 206 that apply to data within other data sets.

In embodiments, automated identification of dimensions and measures of interest, based on performing calculations on many dimensions that potentially contribute to measures of interest, and storing and ranking measures using time-period variances or other statistics may enable various business relevant analytic activities that were not previously possible. This may include projecting a change in a business performance measure based on analysis of differences over time of contributing data elements that, when processed through a hospital operations measurement and performance analysis factory, are used to calculate the business performance measure. For example, a business measure that appears stable may be projected to change based on discovery of an event in a contributing measure that is likely to have later influence on the higher-level measure. For example, if a hospital has had stable occupancy, but a measure of the diagnoses (disease conditions) of current patients indicates a high increase in the fraction of easily treatable conditions (when divided by all conditions), then an analyst may project a decrease in occupancy that would not have been found without the computer-automated calculation of many such measures. Such projections may also be performed automatically, such as using change in underlying measures to identify measures for which projections are to be performed, automatically performing the projections, and automatically ranking, presenting, or highlighting projections that vary significantly from normal patterns for the applicable business measures.

Other uses of the analytic system may include suggesting a dimension, a measure, and/or a business-relevant event or activity as a source of a variance between two business-centric performance measures of a business, where the measures that suggest the variance are automatically generated by processing (such as with a hospital operations measurement and performance analysis factory, such as using automated processing rules noted herein) many-dimensional data representing activities of the business. Similarly, the methods and systems disclosed herein may enable suggesting an event that is characterized by data within a data set as a source of a variance between two business-centric performance measures of a business, where the measures are automatically generated by processing (such as with an automated hospital operations measurement and performance analysis factory according to the various embodiments disclosed herein) data representing activities of the business.

Measures of interest, projections, events, dimensions, facts, summaries and the like that are identified by automated analysis (such as time-variance analysis) of automatically generated and calculated measures (such as in a hospital operations measurement and performance analysis factory approach described throughout this disclosure), may be displayed in a dashboard, such as an operational dashboard for a business or other enterprise that automatically presents one or more such results. This may include, for example, contributors to notable variances of a measure of business performance (such as over time), where the contributors may be determined from sources of measures as defined by a set of factory rules 206 of a hospital operations measurement and performance analysis factory, the contributors may be tagged with a variance-impact confidence factor, and the dashboard may be automatically configured based on a determined role of a user of the dashboard. The operational dashboard may automatically re-configure to show the most relevant measure of interest, not only based on the role of the user, but based on variances described above, such as in the underlying data that is used to calculate one or more measures. In embodiments, contributors to measures may be further automatically filtered based on the determined role of the user, so that sources of data for contributors associated with the determined role of the user are represented in the dashboard (such as by descriptive information about role-specific business activities) that correspond to the sources of data for the filtered contributors. For example, a doctor may be presented with measures, projections, or the like where contributing data indicates high variances in data about disease conditions, diagnoses, patient outcomes, and the like, while a financial operator may be presented with information about measures, projections, events, or the like that involve time-variances in contributing data about occupancy rates, insurance, re-admissions, and the like.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A hospital operations measurement and performance analysis factory for generating analytic measures, comprising:
a plurality of data sets comprised of data representing business activities arranged as a columnar array wherein each column is associated with a distinct source rule that applies to the column when it is used as a data source;
a plurality of factory rules that govern which operations on available data sources may be executed under what conditions in the hospital operations measurement and performance analysis factory;
a factory rule execution hierarchy that executes ready calc, flag, and lookup rules before executing ready link and ready plugin rules; and
an analytic measures rendering circuit that gathers a subset of the analytic measures produced by applying the plurality of factory rules per the factory rule execution hierarchy to a portion of the plurality of data sets into a structured set of discrete panels, wherein each analytic measure in the subset of measures is rendered in one panel in the subset of discrete panels.

2. The factory of claim 1, wherein an order in which factory rules are presented to the hospital operations measurement and performance analysis factory is independent of an order in which the presented factory rules are applied to the plurality of data set.

3. The factory of claim 1, wherein a factory rule is determined to be ready when data of the plurality of data sets that the factory rule requires is available in one or more of the plurality of data sets.

4. The factory of claim 1, wherein data required by at least one factory rule is available when at least one of the following conditions exists:
(a) the data is determined only by application of source rules; and
(b) the data is generated by another factory rule the processing of which is complete for data that the at least one factory rule requires.

5. The factory of claim 1, wherein factory rules that lack dependency on other factory rules are applied before applying factory rules that have dependency on other factory rules.

6. The factory of claim 1, wherein the analytic measure rendering circuit is structured to facilitate rendering of the plurality of discrete panels, wherein a value of an analytic measure of the plurality is calculated for at least two different time frames and a comparison thereof is rendered in each discrete panel.

7. The factory of claim 1, wherein the analytic measure rendering circuit indicates a visual order of factory measure presentation on a small form factor electronic display.

8. The factory of claim 7, wherein the order of factory rule execution further requires the ready calc, flag, and lookup rules to execute before the ready link rules which execute before the ready plugin rules.

9. The factory of claim 1, further comprising a measure-specific circuit generation facility generates a circuit for executing a combination of source rules and factory rules on a subset of the plurality of data sets to produce a first measure, the facility generates the circuit based on a data graph derived from the plurality of data sets in the factory rules.

10. The factory of claim 9, wherein the circuit generation facility generates the data graph as part of a process to create the circuit.

11. The factory of claim 9, wherein the circuit generation facility selects among a plurality of factory rules based on an effectivity date associated with each of the plurality of factory rules and a circuit target date.

12. The factory of claim 11, wherein the circuit target date is the date on which the circuit is generated.

13. The factory of claim 11, wherein the circuit target date is an effectivity date of the circuit.

14. A method of automated measurement of business performance, comprising:
configuring a plurality of business performance hospital operations measurement and performance analysis factory rules as relationships of data source rules and of other factory rules;
arranging a plurality of data sets with data representing business activities as columnar arrays wherein each column is associated with a distinct source rule;
generating a circuit for processing the plurality of data sets from the factory rules based on a factory rule execution hierarchy that executes factory rules that lack dependency on other factory rules before executing factory rules that have dependency on the other factory rules; and
processing the plurality of data sets with the generated circuits to produce a business measure.

15. The method of claim 14, wherein an order in which factory rules are presented to the hospital operations measurement and performance analysis factory is independent of an order in which the generated circuit executes the presented factory rules.

16. The method of claim 14, wherein a factory rule is determined to be ready when data that the factory rule requires is available in one or more of the plurality of data sets.

17. The method of claim 14, wherein the data is treated as available when at least one of the following conditions exist:
(a) if it is determined only by application of source rules; and
(b) if it is generated by another factory rule the processing of which is complete for the data that the factory rule requires.

18. The method of claim 14, wherein a ready calc factory rule is applied before other factory rules.

19. The method of claim 14, wherein a ready flag rule is applied after all ready calc rules have been applied per the circuit.

20. An apparatus for providing an analytic measure rendering:
a data gathering circuit structured to:
communicate with a hospital operations measurement and performance analysis factory; and
gather a plurality of analytic measurements produced via the hospital operations measurement and performance analysis factory by applying a plurality of factory rules to a plurality of data sets based on a factory rule execution hierarchy, wherein the factory rule execution hierarchy executes ready calc, flag, and lookup rules before executing ready link and ready plugin rules; and a rendering circuit structured to:
generate a plurality of panels for display in a graphical user interface; and
render at last one of the plurality of analytic measurements in a corresponding panel of the plurality of panels.
